(19) United States
(12) Patent Application Publication
(10) Pub. No.: US 2025/0377489 A1
(43) Pub. Date: Dec. 11, 2025

(54) LIGHT SHIELDING UNIT AND LENS BARREL EQUIPPED WITH SAME

(71) Applicant: Panasonic Intellectual Property Management Co., Ltd., Osaka (JP)

(72) Inventors: Tetsuya UNO, Osaka (JP); Satoshi FUKUDA, Osaka (JP)

(73) Assignee: Panasonic Intellectual Property Management Co., Ltd., Osaka (JP)

(21) Appl. No.: 19/230,191

(22) Filed: Jun. 6, 2025

(30) Foreign Application Priority Data
Jun. 11, 2024 (JP) 2024-094605

(51) Int. Cl. G02B 5/00

(52) U.S. Cl. CPC G02B 5/005

(57) ABSTRACT

The aperture unit 20 comprises a base plate 21, a drive ring 22, a plurality of aperture blades 23, a drive motor 24, and a drive gear 24a. The plurality of aperture blades 23 are disposed between the base plate 21 and the drive ring 22, and adjust the amount of light passing through by changing the size of an opening 23b through which passes the light passing through an opening 21b. The drive motor 24 rotationally drives the drive ring 22 around the optical axis. The drive ring 22 is engaged in a state of being rotatable around the optical axis relative to the base plate 21 and being substantially immobile in the optical axis direction, further to the outside in the radial direction centered on the optical axis than the plurality of aperture blades 23. When the drive ring 22 is rotated relative to the base plate 21 by the drive motor 24, the plurality of aperture blades 23 are driven open and closed in the gap between the base plate 21 and the drive ring 22.

### CROSS-REFERENCE TO RELATED APPLICATIONS

This application claims priority to Japanese Patent Application No. 2024-094605 filed on Jun. 11, 2024. The entire disclosure of Japanese Patent Application No. 2024-094605 is hereby incorporated herein by reference.

### BACKGROUND

### Technical Field

The present disclosure relates to a light shielding unit and a lens barrel equipped with the same.

### Description of the Related Art

An imaging device such as a camera is provided with a plurality of lens groups, a aperture that adjusts the surface area of an opening through which light passes, a shutter unit, and so forth.

For example, Patent Literature 1 discloses a blade drive mechanism for a camera, which includes a synthetic resin base plate that has a cylindrical part formed protruding on one side at a lateral position of the exposure opening and being open on the other side, at least one stator yoke having a coil wound around it, having a magnetic pole part at the distal end inserted into a groove formed in the circumferential surface of the cylindrical part, and having a base attached to one side of the base plate, a permanent magnet rotor inserted from the other side of the base plate and rotatably disposed inside the cylindrical part, with the circumferential surface thereof opposite the magnetic pole part of the stator yoke, a gear that is integral with the rotor and rotates outside the cylindrical part, a drive ring having teeth that mesh with the gear and rotatably disposed around the exposure opening, and a plurality of blades that operate to open or close the exposure opening depending on the direction of rotation of the drive ring.

### CITATION LIST

### Patent Literature

Patent Literature 1: JP-A 2001-201780
Patent Literature 2: JP-A 2015-079105

### SUMMARY

### Problem to be Solved by the Invention

However, the following problem is encountered with the above-mentioned conventional light shielding unit.

The blade drive mechanism for a camera disclosed in the above publication includes a light shielding unit that opens and closes a plurality of movable blades by using a motor to rotationally drive a second frame body (drive ring) that is sandwiched between an annular first frame body (base plate) and a third frame body (cover).

However, with a light shielding unit configuration such as this, three annular members, namely, a first frame body (base plate), a second frame body (drive ring), and a third frame body (cover), are needed to drive a plurality of movable blades open and closed. The problem with this configuration is that the size increases in the thickness direction (optical axis direction) and the number of parts increases, resulting in higher costs.

It is an object of the present disclosure to provide a light shielding unit with which there is less of an increase in size in the optical axis direction and fewer parts are required, thereby reducing costs, as well as a lens barrel equipped with this light shielding unit.

### Means for Solving Problem

The light shielding unit according to the present disclosure includes a first frame body, a second frame body, a drive source, one or more rotational drive transmission units, and a plurality of movable blades. The first frame body has a substantially annular first main body part, and a first opening that is provided in the center part of the first main body part and allows light to pass through in the optical axis direction. The second frame body has a substantially annular second main body part, a second opening that is provided in a center part of the second main body part and allows light to pass through in the optical axis direction, and a rotation connection portion that is provided to the second main body part. The second frame body is engaged with the first frame body in a state of being rotatable around the optical axis. The drive source is held by the first frame body and rotationally drives the second frame body around the optical axis relative to the first frame body. The one or more rotational drive transmission units transmit the rotation or the rotational drive force transmitted from the drive source to the rotation connection portion. The plurality of movable blades are at least partially disposed in the space formed between the first frame body and the second frame body, and form a third opening through which passes the light that has passed through the first opening or the second opening. The plurality of movable blades are driven open or closed when the second frame body is rotated relative to the first frame body by the drive source, and adjust the amount of light passing through by changing the size of the third opening by opening or closing.

(EFFECTS)

With the light shielding unit according to the present disclosure, an increase in size in the optical axis direction is less likely, and the number of parts can be reduced, which helps keep the cost low.

### BRIEF DESCRIPTION OF THE DRAWINGS

FIG. 1 is a cross-sectional view of the configuration of a lens barrel including the aperture unit according to an embodiment of the present disclosure;

FIG. 2 is an oblique view of the configuration of the aperture unit in FIG. 1 as viewed from the image plane side in the optical axis direction;

FIG. 3 is an oblique view of the configuration of the aperture unit in FIG. 1 as viewed from the subject side in the optical axis direction;

FIG. 4 is a plan view of the configuration of the base plate included in the aperture unit in FIG. 2, etc. (an oblique view as seen from the subject side in the optical axis direction);

FIG. 5 is a plan view of the configuration of the drive ring included in the aperture unit shown in FIG. 2, etc. (an oblique view as seen from the subject side in the optical axis direction).

FIG. 6A is a plan view (a perspective view as seen from the subject side in the optical axis direction) of the maximum aperture (fully open, maximum opening) state of the aperture blades included in the aperture unit in FIG. 2, etc.;

FIG. 6B is a plan view (a perspective view as seen from the subject side in the optical axis direction) of the minimum aperture (minimum opening) state of the aperture blades included in the aperture unit of FIG. 2, etc.;

FIG. 7 is a plan view of the configuration of the aperture blades in FIG. 6A, etc. (as viewed from the subject side in the optical axis direction);

FIG. 8 is a perspective view as seen from the subject side in the optical axis direction, showing the state of the rotation angle position of the drive ring relative to the base plate at the assembly start position (bayonet assembly start position, bayonet tab insertion position) of the aperture unit in FIG. 2, etc.;

FIG. 9 is a perspective view as seen from the subject side in the optical axis direction, showing the state of the rotation angle position of the drive ring relative to the base plate at the assembly completion position (bayonet assembly completion position, bayonet coupling position) of the aperture unit in FIG. 2, etc., and at the maximum aperture position of the aperture blades (fully open position, maximum aperture position); and

FIG. 10 is a perspective view as seen from the subject side in the optical axis direction, showing the state of the rotation angle position of the drive ring relative to the base plate at the minimum aperture position (minimum opening position) of the aperture blades of the aperture unit in FIG. 2, etc.

### DETAILED DESCRIPTION OF THE EMBODIMENT

Embodiments will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

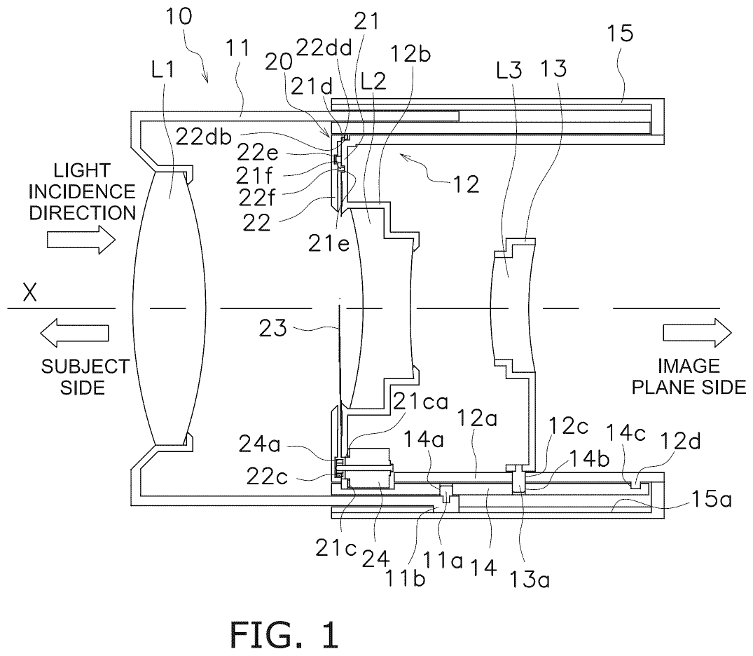

The “subject side,” “image side,” and “incident direction of light” mentioned in the text are shown in FIG. 1. The “image plane side” and the “opposite side from the subject side” are the same side.

### Embodiment 1

An aperture unit (light shielding unit) 20 according to an embodiment of the present disclosure, and a lens barrel 10 equipped with this aperture unit will now be described with reference to FIGS. 1 to 10.

### (1) Configuration of Lens Barrel 10

The lens barrel 10 according to this embodiment is a lens barrel that is mounted on a camera body (not shown), and as shown in FIG. 1, includes a first lens group unit 11, a second lens group unit 12, a third lens group unit 13, a cam frame 14, a rectilinear frame 15, first to third lenses L1 to L3, and an aperture unit 20. X is the optical axis defined by the first lens L1 to the third lens L3. The optical axis X may instead be defined by any one lens, such as the first lens L1.

As shown in FIG. 1, the first lens group unit 11 is a substantially cylindrical member that holds the first lens L1 on the side closest to the subject in the optical axis X direction, and is provided so as to move back and forth in the optical axis X direction. The first lens group unit 11 has a cam pin 11a that protrudes radially inward from the inner circumferential surface, and a rectilinear protrusion 11b that protrudes radially outward from the outer circumferential surface.

As shown in FIG. 1, the cam pin 11a engages with a cam groove 14a provided in the cam frame 14, and the rectilinear protrusion 11b engages with a rectilinear groove 15a provided on the inside diameter side of the rectilinear frame 15, constituting a cam mechanism. When the cam frame 14 rotates relative to the rectilinear frame 15 substantially around the optical axis X, this cam mechanism causes the first lens group unit 11 to move back and forth in the optical axis X direction.

As shown in FIG. 1, the second lens group unit 12 is a substantially cylindrical member that holds the second lens L2 on the image plane side in the optical axis X direction of the first lens L1. As shown in FIG. 1, the second lens group unit 12 is such that a substantially cylindrical main body 12a, a lens holding portion 12b that holds the second lens L2, and a base plate 21 that constitutes an aperture unit 20 (discussed below) are formed substantially integrally. Furthermore, the second lens group unit 12 has a rectilinear groove 12c provided to the main body 12a on the inner peripheral surface side, for guiding a third lens group unit 13, which is disposed closer to the image plane side than the second lens L2, in the optical axis X direction, and the third lens group unit 13 can be moved back and forth in the optical axis X direction along the rectilinear groove 12c. A bayonet rib 12d that engages with a bayonet groove 14c of the cam frame 14 is provided on the outer peripheral surface side of the main body 12a of the second lens group unit 12, and the cam frame 14 is disposed in a state of being substantially rotatable around the optical axis X but immobile in the optical axis X direction when the bayonet rib 12d is engaged with the bayonet groove 14c.

As shown in FIG. 1, the third lens group unit 13 is disposed on the inner peripheral surface side of the second lens group unit 12 in a state of holding the third lens L3, and moves back and forth in the optical axis X direction. The third lens group unit 13 has a cam pin 13a that protrudes radially outward from the outer peripheral surface.

As shown in FIG. 1, the cam pin 13a is engaged with a cam groove 14b provided to the cam frame 14 and a rectilinear groove 12c provided to the main body 12a of the second lens group unit 12, constituting a cam mechanism. When the cam frame 14 rotates relative to the second lens group unit 12 substantially around the optical axis X, this cam mechanism causes the third lens group unit 13 to move back and forth in the optical axis X direction.

As shown in FIG. 1, the cam frame 14 is a substantially cylindrical member that is disposed on the outer peripheral surface side of the main body 12a of the second lens group unit 12, and is rotationally driven by a manual operation force (not shown), and is provided with a bayonet groove 14c that engages with the bayonet rib 12d, and is provided in a state of being rotatable relative to the second lens group unit 12 around the optical axis X. The cam frame 14 includes a cam groove 14a that engages with the cam pin 11a of the first lens group unit 11, and a cam groove 14b that engages with the cam pin 13a of the third lens group unit 13. When a zoom operation ring (not shown), which is disposed further to the outside than the rectilinear frame 15 and is rotatable around the optical axis X, is rotated by a manual operation, a manual operation force is transmitted from the zoom operation ring (not shown) to the cam frame 14 via an interlocking pin (not shown) linked to the manual operation ring (not shown) and the cam frame 14.

The cam groove 14a and 14b are grooves that pass through the outer peripheral surface and inner peripheral surface of the cam frame 14, and are formed obliquely to the optical axis X direction when viewed from the side (outer peripheral side) of the lens barrel 10. In other words, the cam grooves 14a and 14b are grooves formed in the cylindrical portion along a substantially spiral path centered on the optical axis X. When the cam frame 14 is rotated by a manual operating force (not shown), the cam pins 11a and 13a move along the substantially spiral cam grooves 14a and 14b, which allows the first lens group unit 11 and the third lens group unit 13 to move back and forth in the optical axis X direction relative to the cam frame 14 and the second lens group unit 12.

As shown in FIG. 1, the rectilinear frame 15 is disposed on the outside diameter side of the first lens group unit 11 centered on the optical axis X, and is integrally engaged with the second lens group unit 12 on the image plane side. The rectilinear frame 15 is provided with a rectilinear groove 15a on its inner peripheral surface that engages with the rectilinear protrusion 11b of the first lens group unit 11, allowing the first lens group unit 11 to move back and forth in the optical axis X direction along the rectilinear groove 15a.

As shown in FIG. 1, the first to third lenses L1 to L3 are an optical system that guides light in the optical axis X direction, and are disposed in that order from the subject side to the image plane side in the direction of light incidence.

The first lens L1 is disposed inside the first lens group unit 11 and on the subject side, and is disposed closest to the subject of all the lens groups included in the lens barrel 10.

The second lens L2 is disposed on the image plane side (the opposite side from the subject side) of the first lens L1. Furthermore, the second lens L2 is disposed inside the second lens group unit 12 and on the subject side.

The third lens L3 is disposed inside the third lens group unit 13 at a position that is a certain distance away from the second lens L2 toward the image plane side.

As shown in FIG. 1, the aperture unit (light shielding unit) 20 is disposed between the second lens L2 of the second lens group unit 12 and the first lens L1 of the first lens group unit 11, and adjusts the surface area or aperture diameter through which passes light transmitted through the first lens L1, thereby adjusting the amount of light incident on an image sensor provided on the camera body side. The detailed configuration of the aperture unit 20 will be described below.

### (2) Configuration of Aperture Unit 20

With the lens barrel 10 of this embodiment, as shown in FIG. 1, the first to third lenses L1 to L3 are disposed in that order starting from the subject side in the optical axis X direction.

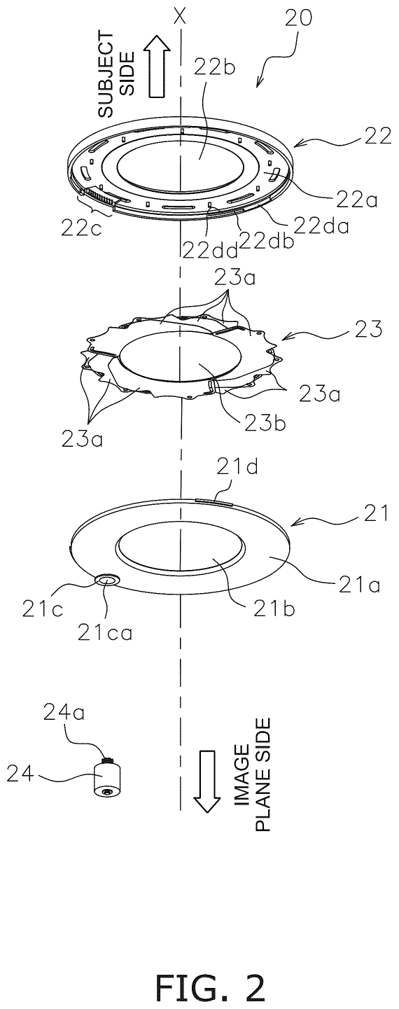

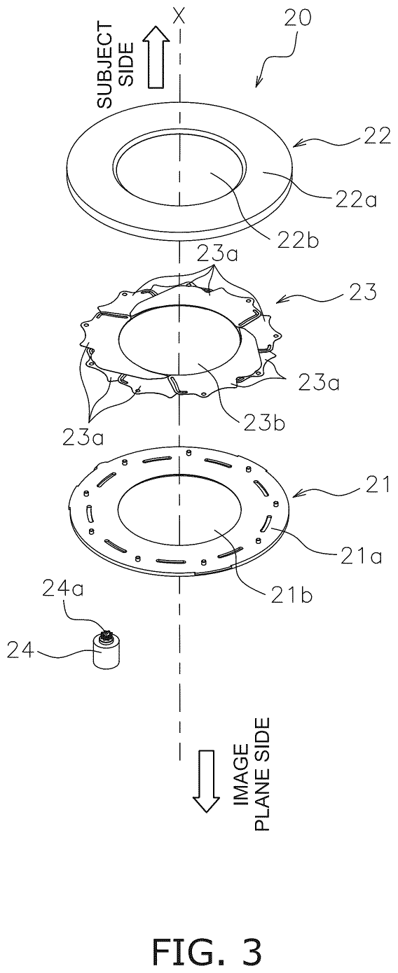

As shown in FIG. 1, the aperture unit 20 is disposed upstream of the second lens L2 and is configured substantially integrally with the second lens group unit 12. More specifically, with the lens barrel 10 of this embodiment, the second lens group unit 12 and the base plate 21 (discussed below) are integrated. This allows the lens barrel 10 or the second lens group unit 12 to be more compact in the optical axis X direction and to have fewer parts as compared to when the base plate 21 and the second lens group unit 12 are configured as separate components. As shown in FIG. 2, the aperture unit 20 adjusts the opening diameter (opening 23b, third opening) by rotating the plurality of aperture blades 23 (see FIG. 3) with the drive motor (drive source) 24 to open and close the blades and adjust the amount of light passing through the openings (aperture openings) 21b, 22b, and 23b formed at the center of each substantially annular member. The centers of the openings 21b, 22b, and 23b and the opening of the aperture unit 20 are configured to substantially pass through the optical axis X.

As shown in FIGS. 2 and 3, the aperture unit 20 has the base plate (first frame body) 21, the drive ring (second frame body) 22, the aperture blades (movable blades) 23, and the drive motor (drive source) 24.

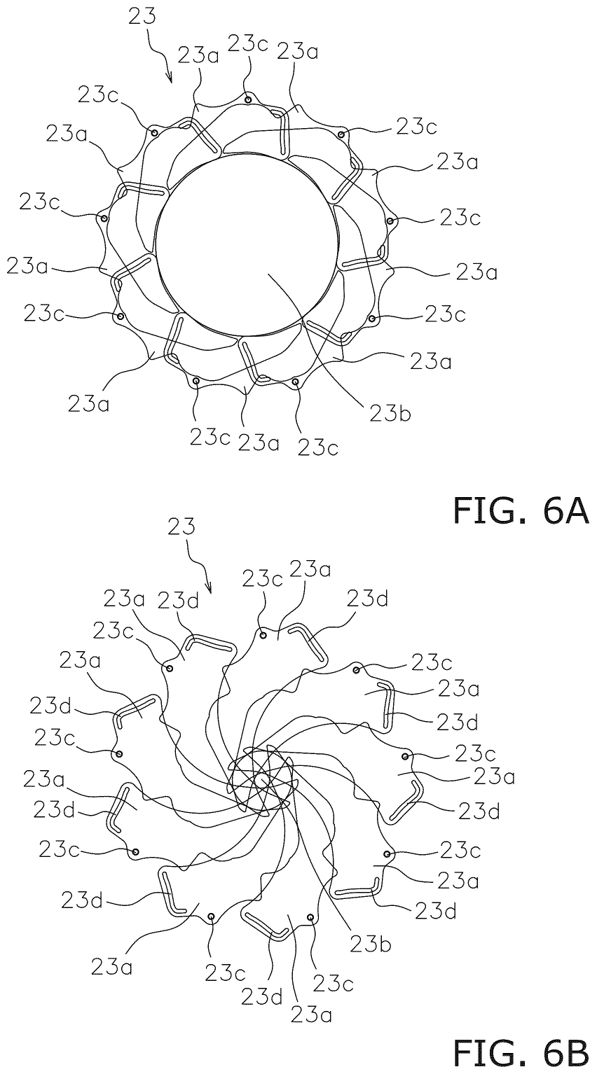

In the aperture unit 20, when the aperture blades 23 are constricted all the way (minimum aperture state), the opening diameter (surface area) of the opening (third opening) 23b formed by the aperture blades 23 is at its smallest (minimum opening state) (see FIG. 6B). In the fully constricted state (minimum aperture state), the tip portions 23e of the aperture blades 23 are inserted all the way in, further to the inside than the opening (first opening) 21b and the opening (second opening) 22b, forming the opening (third opening) 23b with the smallest opening diameter (surface area).

From a state in which the opening diameter (surface area) of the opening (third opening) 23b is at its smallest, when the aperture blades 23 are rotated clockwise in FIG. 6B around a through-hole 23c, the tip portions 23e move while gradually rotating toward the outside diameter side around the optical axis X, that is, toward the opening (first opening) 21b and the opening (second opening) 22b side, and gradually move into the gap between the base plate 21 and the drive ring 22. As a result, the opening diameter (surface area) of the opening (third opening) 23b formed by the aperture blades 23 gradually increases.

When the aperture blades 23 are further rotated around the through-hole 23c, the tip portions 23e move while rotating further around the optical axis X toward the outside diameter side, and the aperture blades 23, except for the blade portions 23a or part of the tip portions 23e, or almost the entirety of them, move into the gap between the base plate 21 and the drive ring 22, resulting in a state in which the opening diameter (surface area) of the opening (third opening) 23b formed by the aperture blades 23 is at its maximum, that is, the maximum aperture state (maximum opening state, open state, fully open state) (see FIG. 6A).

As discussed above, the aperture unit 20 of this embodiment can adjust the amount of light passing through the opening (third opening) 23b by rotating the aperture blades 23 between their minimum aperture state and their maximum aperture (fully open) state.

As shown in FIGS. 2 and 3, the base plate (first frame body) 21 is a substantially annular member that is disposed closer to the image plane side than the drive ring 22 and the aperture blades 23 in the light incidence direction, and has a substantially annular main body part 21a and an opening (first opening) 21b that is formed in the center portion of the main body part 21a to allow light incident from the subject side to pass through. As shown in FIG. 3, a space is formed between the base plate 21 and the drive ring 22, the space expanding in the optical axis X direction and in the radial direction relative to the optical axis X, and the aperture blades 23 are disposed so that they can be opened and closed by rotating around a through-hole 23c within this space.

The configuration of the base plate 21 will be described in detail below.

As shown in FIGS. 2 and 3, the drive ring 22 is a substantially annular member that is disposed closer to the subject side than the base plate 21 and the aperture blades 23 in the light incidence direction, and has a substantially annular main body part 22a and an opening 22b that is formed in the center thereof. The drive ring 22 is rotationally driven relative to the base plate 21 around the optical axis X by the drive motor 24 (discussed below), thereby rotating the aperture blades 23 to open or close.

The configuration of the drive ring 22 will be described in detail below.

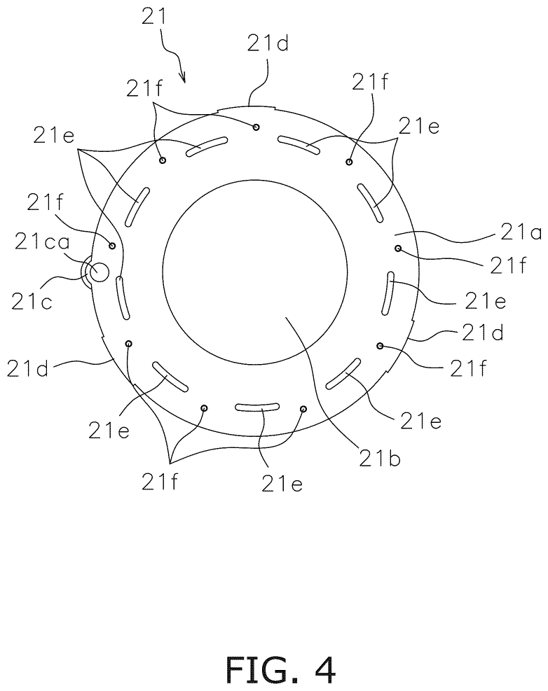

As shown in FIGS. 2 and 3, the aperture blades (movable blades) 23 are disposed so as to be sandwiched between the base plate 21 and the drive ring 22 in the space between these, in the light incidence direction (optical axis X direction). The aperture blades 23 are rotated around rotation shafts 21f (see FIG. 4) provided on the base plate 21 by a known cam mechanism consisting of a cam follower 22f and a cam slot 23d in the space between the base plate 21 and the drive ring 22, thereby changing the size (surface area) of the opening (third opening) 23b and adjusting the amount of light passing through the opening of the aperture unit 20.

The configuration of the aperture blades 23 will be described in detail below.

The drive motor 24 is provided to apply a rotational drive force to the aperture blades 23 when the aperture blades 23 are opened or closed, and is fixed on the outer peripheral side centered on the optical axis of the base plate 21 and so that a drive gear 24a supported by its own rotation shaft is disposed more to the outside diameter side than the range in which one or more aperture blades 23 are operated by the opening and closing drive, that is, further radially outward than the outer shape of at least one aperture blade 23 at the position of maximum aperture. The drive gear 24a is a member serving as a rotational drive transmission unit that transmits rotation via the gear portion 22c to the drive ring 22, and rotates in conjunction with the rotation of the drive motor 24. Consequently, the aperture blades 23 are disposed at positions overlapping the drive gear 24a in the optical axis X direction, but do not interfere with the drive gear 24a, which is a rotational drive transmission unit (rotational drive transmission member), even when the aperture blades 23 are driven opened and closed. The rotation shaft of the drive motor 24 is rotated by power supplied from an electric circuit (not shown).

More specifically, in the drive motor 24, the drive gear 24a, which is a rotational drive transmission unit (rotational drive transmission member), is press-fitted to the rotation shaft, and the drive gear 24a is disposed so as to mesh with a gear portion 22c provided to the drive ring 22. When the rotation shaft of the drive motor 24 rotates in this state, the drive ring 22 rotates around the optical axis X relative to the base plate 21 via the drive gear 24a. When the drive ring 22 rotates relative to the base plate 21, the aperture blades 23 are rotated open or closed by a cam mechanism (discussed below).

In the first embodiment, the base plate 21 is formed substantially integrally as a part of the second lens group unit 12, but this is not the only option. The aperture unit 20 may be separate from the second lens group unit 12 and the two then integrally coupled with screws or some other fastening method. Also, the drive gear 24a was configured as the rotational drive transmission unit that was disposed further to the outside diameter side than the range in which the multiple aperture blades 23 open and close, but this is not the only option. The rotation shaft of the drive motor 24 serving as the rotational drive transmission unit may be disposed further to the outside diameter side than the range in which the multiple aperture blades 23 open and close. In this case, the aperture blades 23 are disposed at positions that overlap the rotation shaft of the drive motor 24 in the optical axis X direction (as viewed from a direction perpendicular to the optical axis X), but are disposed at positions that do not overlap the drive gear 24a. More specifically, the drive gear 24a is disposed closer to the drive ring 22 than the multiple aperture blades 23 in the optical axis X direction, and meshes with the gear portion 22c of the drive ring 22. Therefore, even when the aperture blades 23 are driven open or closed, they will not interfere with the rotation shaft and drive gear 24a of the drive motor 24, which are the rotational drive transmission units.

Also, in the first embodiment, the configuration is such that the rotational drive force is transmitted directly from the drive gear 24a fixed to the drive motor 24 to the gear portion 22c of the drive ring 22, but this is not the only option. One or more intermediate gears supported by the base plate 21 may be added between the gear train of the drive gear 24a fixed to the drive motor 24 and the gear portion 22c of the drive ring 22. The intermediate gears may include a stepped gear with a deceleration effect. Also, in the first embodiment, the configuration is such that the drive gear 24a is disposed as a rotational drive transmission unit further to the outside diameter side than the range in which the multiple aperture blades 23 open and close, but this is not the only option. One or more intermediate gears may be added within the gear train of the drive gear 24a fixed to the drive motor 24 and the gear portion 22c of the drive ring 22, and one or more of the drive gear 24a and the one or more intermediate gears may be disposed as a rotational drive transmission unit further to the outside diameter side than the range in which the aperture blades 23 open and close.

### (2-1) Base Plate 21

As shown in FIG. 4, the base plate (first frame body) 21 has the main body part (first main body part) 21a, the opening (first opening) 21b, an attachment portion 21c, tabs 21d, grooves 21e, and rotation shafts 21f.

Also, as shown in FIG. 2, the drive motor 24 is disposed on the image plane side surface of the base plate 21 for applying drive force to drive the aperture blades 23 open and closed.

As shown in FIG. 4, the main body part (first main body part) 21a is a substantially annular plate-like member that forms some or all of the exterior shape of the aperture unit 20 on the image plane side in the optical axis X direction, and has an opening 21b formed in its center.

As shown in FIG. 2, etc., the opening (first opening) 21b is an open portion through which passes light that is incident from the subject side of the lens barrel 10, and has a diameter or surface area that is approximately the same as, or slightly larger than, or slightly smaller than, that of the opening (third opening) 23b that is formed when the multiple aperture blades 23 are fully open (maximum opening).

In the first embodiment, the main body part 21a and the opening (first opening) 21b are integrally configured as the same member, but this is not the only option. The two may be integrally configured in a state in which a separate member that includes the opening (first opening) 21b, such as a sheet-like member (not shown) that is thin in the optical axis X direction, is supported by the main body part 21a.

As shown in FIG. 2, the attachment portion 21c is provided on the image plane side of the base plate 21 to which the drive motor 24 is attached. As shown in FIG. 4, the attachment portion 21c has a through-hole 21ca in its center.

The drive gear 24a of the drive motor 24 is inserted into the through-hole 21ca. The drive motor 24 is attached to the attachment portion 21c of the base plate 21 by passing the drive gear 24a through the through-hole 21ca and fastening with an attachment screw (not shown). Consequently, the drive gear 24a engages with the gear portion 22c on the drive ring 22 side via the base plate 21.

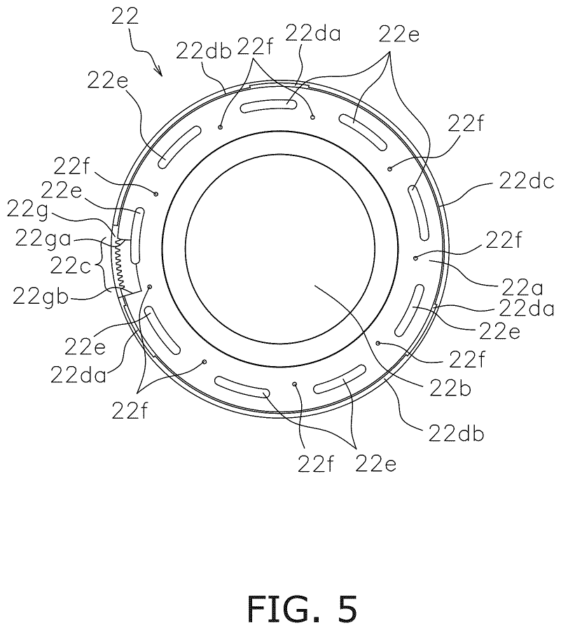

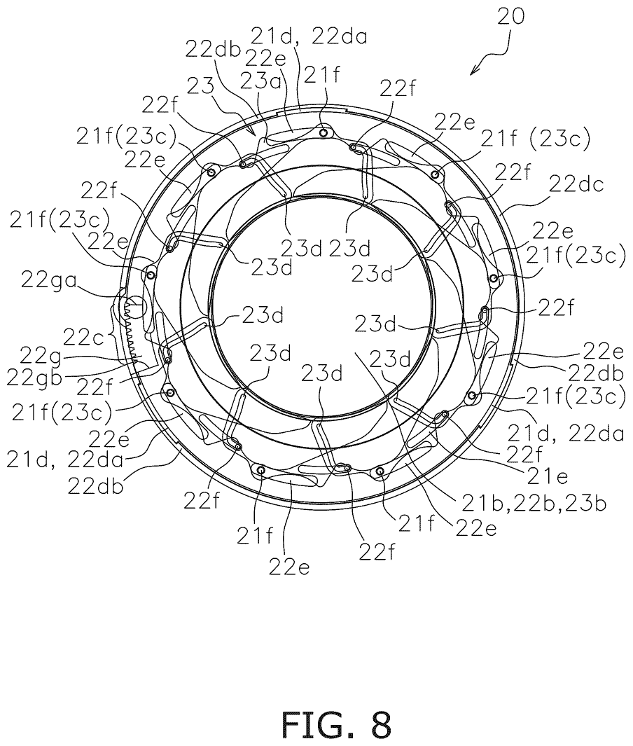

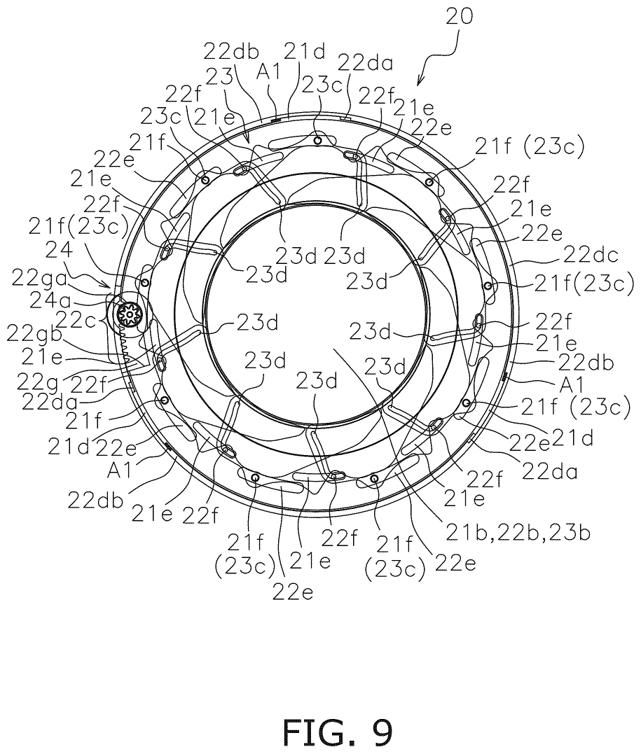

The tabs 21d are parts that constitute a bayonet coupling in which the drive ring 22 is supported rotatably around the optical axis X while being substantially integral with the base plate 21 in the optical axis X direction, and are provided at three locations at substantially equal angular intervals (about 120 degrees) centered on the optical axis X, so as to protrude from the outer peripheral portion of the substantially annular main body part 21a by a specific width in the radial direction centered on the optical axis X. The tabs 21d are provided at three places around the circumferential direction on the outer peripheral side of the main body part 21a of the base plate 21. During assembly, as shown in FIG. 8, the tabs 21d are first inserted in the optical axis X direction from insertion portions 22da provided on the drive ring 22 side (discussed below) at the assembly start position, and fitted into the inside diameter side of the outer peripheral wall 22dc of the drive ring 22. From that state, the drive ring 22 is rotated by a specific angle relative to the base plate 21 around the optical axis X, and as a result, as shown in FIG. 9, the tabs 21d move under latching portions 22db (downward in the direction perpendicular to the drawing plane in FIG. 5), and the rotation angle position of the drive ring relative to the base plate moves to the assembly completion position (bayonet assembly completion position, bayonet coupling position), thereby achieving an assembly completion state.

Consequently, the tabs 21d are sandwiched between the latching portions 22db and the main body part 22a within the above-mentioned specific angle range, and the base plate 21 and the drive ring 22 are substantially integrated so as not to separate in the optical axis X direction, and can be connected in a state of being able to rotate relatively around the optical axis X.

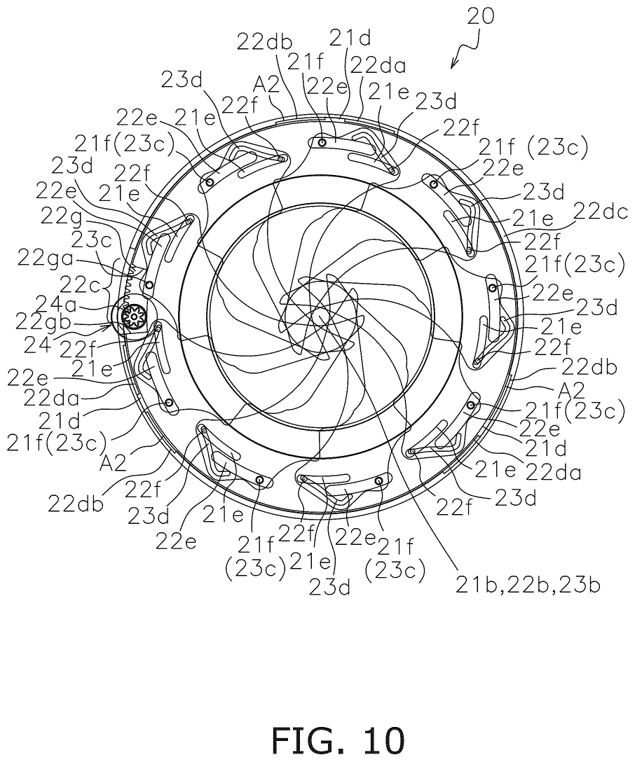

As shown in FIGS. 9 and 10, when the drive ring 22 is further rotated relative to the base plate 21 around the optical axis X when the rotation angle position of the drive ring relative to the base plate is the assembly completion position (bayonet assembly completion position, bayonet coupling position), the aperture unit 20 enters its usage state (light amount adjustable state) in which the amount of light passing through can be adjusted, and transitions from the maximum aperture position to the minimum aperture position according to the rotation of the drive ring 22.

As shown in FIG. 4, the grooves 21e are bottomed groove that are disposed on the inner peripheral side of rotation shafts 21f centered on the optical axis X, and have a bottom formed in an arc shape, and these are provided at nine locations along the circumferential direction on the surface of base plate 21 that is opposite the drive ring 22. The grooves 21e are escape grooves that prevent interference when the tips of the cam followers 22f (see FIG. 5) on the drive ring 22 side move in the circumferential direction around the optical axis X with the tips inserted (see FIGS. 8 to 10).

The grooves 21e are grooves having a depth in the optical axis X direction equal to or greater than the amount of protrusion of the tips of the cam followers 22f so as not to interfere with the tips protruding from the cam slot 23d in the optical axis X direction. When the drive ring 22 rotates relative to the base plate 21 from the assembly start position to the assembly completion position (maximum aperture position) and from the assembly completion position (bayonet assembly completion position, bayonet coupling position, maximum aperture position) to the minimum aperture position, the cam followers 22f also rotate relative to the base plate 21, that is, move in the circumferential direction, by the same angle. Accordingly, the grooves 21e have a circumferential length relative to the optical axis X that is sufficient to prevent interference with the cam followers 22f in the circumferential direction centered on the optical axis X even if the drive ring 22 rotates relative to the base plate 21 by approximately the rotation angle from the assembly start position through the assembly completion position (bayonet assembly completion position, bayonet coupling position, maximum aperture position) to the minimum aperture position.

Consequently, even if the drive ring 22 rotates around the optical axis X relative to the base plate 21 in the assembled state and in the usage state (light amount adjustment state), the cam followers 22f on the drive ring 22 side can move in the circumferential direction around the optical axis X along the grooves 21e without interfering with each other in the circumferential direction inside the grooves 21e, so the aperture blades 23 can be driven open and closed without any problem.

That is, even if the base plate 21 and the drive ring 22 rotate relatively around the optical axis X in an assembled state, the base plate 21 will not restrict the rotation of the drive ring 22.

The cam followers 22f on the drive ring 22 side are inserted into the cam slots 23d of the aperture blades 23, but the engagement length in the optical axis X direction needs to be long enough that the mutual engagement will not be easily disengaged by an external force or the like. Therefore, the cam followers 22f pass through the cam slots 23d and protrude in the optical axis X direction by a specific length beyond the thickness of the aperture blades 23. The grooves 21e have a depth in the optical axis X direction that is equal to or greater than the amount of protrusion so that there is no interference with the tips of the cam followers 22f protruding beyond the cam slots 23d in the optical axis X direction. Therefore, there is no interference between the two.

The rotation shafts 21f are provided on a surface opposite the drive ring 22 as rotation shafts of the aperture blades 23. Nine of the rotation shafts 21f are provided on the outer peripheral side of the main body part 21a relative to the optical axis X and on the outer peripheral side (outside diameter side) of the cam followers 22f of the drive ring 22 relative to the optical axis X at approximately equal intervals in the circumferential direction centered on the optical axis X (see FIG. 9, etc.). The rotation shafts 21f are provided facing the drive ring 22 in the optical axis X direction from the surface on the subject side of the substantially annular main body part 21a. The rotation shafts 21f are inserted into the grooves 22e (see FIG. 5, etc.) of the nine aperture blades 23 and function as the rotational centers of each of the aperture blades 23.

The rotation shafts 21f are inserted into the through-holes 23c of the aperture blades 23, but the engagement length in the optical axis X direction needs to be long enough that the mutual engagement is not easily disengaged by an external force or the like. Therefore, the rotation shafts 21f pass through the through-holes 23c and protrude in the optical axis X direction by a specific length beyond the thickness of the aperture blades 23. The grooves 22e have a depth in the optical axis X direction equal to or greater than the amount of protrusion so that there is no interference with the tips of the rotation shafts 21f protruding from the through-holes 23c in the optical axis X direction. Therefore, the two do not interfere with each other. Details of the grooves 22e will be discussed below.

### (2-2) Drive Ring 22

The drive ring 22 is a member that holds the aperture blades 23 in the gap between the drive ring 22 and the base plate 21, that is, a space extending in the optical axis X direction and in the radial direction relative to the optical axis X, and rotates relative to the base plate 21 to open and close the aperture blades 23 by rotation, thereby adjusting the size of the opening diameter (third opening), and as shown in FIG. 5, has a substantially annular main body part (second main body part) 22a, an opening (second opening) 22b formed in the center thereof, a gear portion 22c, insertion portions 22da, latching portions 22db, an outer peripheral wall 22dc, a bayonet groove 22dd, grooves 22e, nine cam followers 22f, and a recess 22g. The drive ring 22 is rotationally driven around the optical axis X by the drive motor 24 relative to the base plate 21, thereby rotating the aperture blades 23 and adjusting the opening surface area (the opening surface area of the opening (third opening) 23b) of the aperture unit 20.

In this embodiment, the outside diameter (outside diameter of the main body part 22a) and inside diameter (diameter of the opening 22b) of the drive ring 22 relative to the optical axis X are approximately the same size (length) as the outside diameter (outside diameter of the main body part 21a) and inside diameter (diameter of the opening 21b) of the base plate 21 relative to the optical axis X, respectively, but this is not the only option.

When the aperture blades 23 are being opened or closed, so long as the rotation shafts 21f, the cam followers 22f, and the cam slots 23d are disposed so as to overlap the drive ring 22 when viewed in the optical axis X direction, the outside diameter and the inside diameter of the drive ring 22 do not have to be approximately the same as those of the base plate 21. Also, when the aperture blades 23 are being opened or closed, so long as the drive gear 24a, which is a rotational drive transmission unit, is disposed so as to overlap the drive ring 22 when viewed in the optical axis X direction, the outside diameter and the inside diameter of the drive ring 22 do not have to be approximately the same as those of the base plate 21.

As shown in FIG. 5, the main body part (second main body part) 22a is a substantially annular plate-like member that forms some or all of the outer shape of the aperture unit 20 on the subject side in the optical axis X direction, and has an opening 22b formed in its center. The outer shape of the aperture unit 20 in the first side in the optical axis X direction is constituted by some or all of the base plate 21, and the outer shape of the second side opposite to the first side in the optical axis X direction is constituted by some or all of the drive ring 22.

The opening (second opening) 22b is an open portion through which passes the light of the aperture unit 20, and has a diameter or surface area that is approximately the same as, or slightly larger than, or slightly smaller than, the opening 23b formed when the aperture blades 23 are in a fully open (maximum opening) state.

In the first embodiment, the main body part 22a and the opening (second opening) 22b are integrally configured as the same member, but this is not the only option. The two may be integrally configured in a state in which a separate member including the opening (second opening) 22b, such as a sheet-like member (not shown) that is thin in the optical axis X direction, is supported by the main body part 22a.

The gear portion 22c is a rotation connection portion for rotating the drive ring 22 in conjunction with the rotation from the drive gear 24a serving as a rotational drive transmission unit. As shown in FIG. 5, the gear portion 22c is provided along the circumferential direction on the outer peripheral side of the substantially annular main body part 22a, facing radially inward from a part of the outer peripheral portion, and is formed so as to mesh with the drive gear 24a (see FIG. 8, etc.) attached to the rotation shaft of the drive motor 24. When the rotational drive force of the drive motor 24 is transmitted through the drive gear 24a, the gear portion 22c rotationally drives the drive ring 22 around the optical axis X relative to the base plate 21. Also, a recess 22g where the thickness of the drive ring 22 is reduced in the optical axis X direction is provided in the inner portion (inside diameter side in the optical axis X direction near the gear portion 22c) from the outer peripheral portion of the main body part 22a where the gear portion 22c is provided, or in other words, the gear portion 22c is provided along the inner wall on the outside diameter side centered on the optical axis X of the recess 22g. The recess 22g will be discussed in detail below.

As shown in FIGS. 5 and 8, the insertion portions 22da have a radial concave amount equal to or greater than the convex amount of the tabs 21d relative to the radial direction, and a width relative to the circumferential direction that is equal to or greater than the width of the tabs 21d, so that the tabs 21d on the base plate 21 side can be inserted from the optical axis X direction when the drive ring 22 and the base plate 21 are coupled. As shown in FIG. 5, three insertion portions 22da are provided at approximately equal angular intervals (about 120 degrees) around the optical axis X on the inner peripheral side of the outer peripheral wall 22dc at the outermost peripheral portion of the main body part 22a.

As shown in FIG. 5, three latching portions 22db are provided at positions adjacent to the insertion portions 22da on the surface of the outer peripheral wall 22dc on the image plane side at the outermost peripheral portion of the main body part 22a, spaced at approximately equal angles (about 120 degrees) from the optical axis X. At the assembly start position shown in FIG. 8, the tabs 21d provided on the base plate 21 side of the latching portions 22db are inserted into the insertion portions 22da, after which the drive ring 22 is rotated around the optical axis X relative to the base plate 21, so that the tabs 21d are partially or entirely inserted into the bayonet groove 22dd formed in the gap between the latching portions 22db and the surface opposite the base plate 21 under the latching portions 22 db (under in the direction perpendicular to the drawing plane in FIG. 5), as shown in FIGS. 9 and 10. As shown in FIG. 2, the bayonet groove 22dd has a specific length in the circumferential direction centered on the optical axis X so that the tabs 21d will not interfere in the circumferential direction when the drive ring 22 rotates such that the rotation angle position of the drive ring 22 relative to the base plate 21 moves from the assembly start position to the assembly completion position (bayonet assembly completion position, bayonet coupling position, maximum aperture position), and then further to the minimum aperture position. This makes it possible for the tabs 21d to rotate relatively along the inside of the bayonet grooves 22dd formed in the drive ring 22 from the assembly start position to the minimum aperture position. Then, the tabs 21d are in a state of being partially or entirely sandwiched (fitted in the bayonet groove 22dd) between the latching portion 22db and the main body part 22a while ensuring a specific width in the optical axis X direction within a specific rotation angle range of the drive ring 22 from the assembly start state to the minimum aperture state. As a result, this constitutes a bayonet coupling (bayonet mechanism) in which the base plate 21 and the drive ring 22 are restricted from separating in the optical axis X direction and rotation between them around the optical axis X is permitted.

The outer peripheral wall 22dc is a wall-shaped portion that is disposed substantially all the way around the outermost peripheral portion (outer portion) of the main body part 22a, and has a specific length in the optical axis X direction, and in which are formed the insertion portions 22da, the gear portion 22c, the latching portions 22db, and the bayonet grooves 22dd. The bayonet grooves 22dd are provided at three locations along the circumferential direction on the outer peripheral side of the main body part 22a of the drive ring 22.

As shown in FIG. 2, three bayonet grooves 22dd are provided at approximately equal angular intervals (about 120 degrees) around the optical axis X on the inner peripheral side of the outer peripheral wall 22dc at the outer peripheral portion of the main body part 22a, and constitute a bayonet coupling together with the tabs 21d of the base plate 21 as discussed above.

As shown in FIG. 5, the grooves 22e are bottomed grooves (having a bottom) formed in an arc shape and disposed on the outer peripheral side of the cam followers 22f centered on the optical axis X, and nine grooves are provided along the circumferential direction. The grooves 22e are escape grooves for preventing interference even when the tips of the rotation shafts 21f of the aperture blades 23 provided to the base plate 21 move in the circumferential direction in a state in which the tips have been inserted (see FIGS. 8 to 10, etc.).

The grooves 22e have a depth in the optical axis X direction equal to or greater than the amount of protrusion of the rotation shafts 21f so that there will be no interference with the tips of the rotation shafts 21f protruding from the through-holes 23c in the optical axis X direction. When the drive ring 22 rotates relative to the base plate 21 from the assembly start position to the assembly completion position (maximum aperture position) and from the assembly completion position (bayonet assembly completion position, bayonet coupling position, maximum aperture position) to the minimum aperture position, the grooves 22e also rotate, that is, moves in the circumferential direction, by the same angle relative to the base plate 21. Therefore, the grooves 22e have a circumferential length relative to the optical axis X that is sufficient to prevent interference with the rotation shafts 21f in the circumferential direction centered on the optical axis X even when the drive ring 22 rotates relative to the base plate 21 by approximately the rotation angle from the assembly start position, through the assembly completion position (bayonet assembly completion position, bayonet coupling position, maximum aperture position), and to the minimum aperture position.

Consequently, even if the drive ring 22 rotates around the optical axis X relative to the base plate 21 in the assembled state and in the usage state (light amount adjustment state), the rotation shafts 21f on the base plate 21 side can move relatively in the circumferential direction along the grooves 22e without interfering with each other in the circumferential direction around the optical axis X, so the aperture blades 23 are driven open and closed without interference.

When the base plate 21 and the drive ring 22 are assembled and rotate relative to each other around the optical axis X, the drive ring 22 can avoid being restricted by the base plate 21 over the entire range of rotation angles over which it can rotate relative to the base plate 21.

As shown in FIGS. 5, 8, etc., the cam followers 22f are disposed further to the inner peripheral side relative to the optical axis X than the rotation shafts 21f of the base plate 21. The cam followers 22f are nine cylindrical parts provided at approximately equal angular intervals from the surface on the image plane side of the main body part 22a along the optical axis X direction toward the base plate 21, and are inserted into the cam slots 23d provided to nine aperture blades 23 (discussed below).

Consequently, when the drive ring 22 is rotationally driven around the optical axis X, the rotation of the drive ring 22 causes the cam followers 22f to move in the circumferential direction around the optical axis X, and the aperture blades 23 having the cam slots 23d with which the cam followers 22f are engaged are rotated around the rotation shafts 21f by a known cam mechanism.

Therefore, by rotating the drive ring 22 and thereby rotating the nine aperture blades 23, the opening 23b can be opened or closed, and the size of the aperture opening of the aperture unit 20 can be adjusted.

The cam followers 22f are inserted into the cam slots 23d of the aperture blades 23, but the engagement length in the optical axis X direction must be long enough that the mutual engagement will not be easily disengaged by any external force or the like. Therefore, the cam followers 22f pass through the cam slot 23d and protrude in the optical axis X direction by a specific length beyond the thickness of the aperture blades 23. The grooves 21e have a depth in the optical axis X direction equal to or greater than this protruding amount so that there will be no interference with the tips of the cam followers 22f protruding from the cam slots 23d. When the drive ring 22 rotates relative to the base plate 21 from the assembly start position to the assembly completion position (bayonet assembly completion position, bayonet coupling position, maximum aperture position) and from the assembly completion position (bayonet assembly completion position, bayonet coupling position, maximum aperture position) to the minimum aperture position, the cam followers 22f also rotate by the same angle relative to the base plate 21, that is, move in the circumferential direction. Therefore, the grooves 21e have a circumferential length relative to the optical axis X that is long enough, that is, interference will be prevented by an amount equal to the rotation angle from the assembly start position through the assembly completion position (maximum aperture position) to the minimum aperture position.

Consequently, when the drive ring 22 rotates around the optical axis X relative to the base plate 21 in the assembled state and in the usage state (light amount adjustment state), the cam followers 22f on the drive ring 22 side can move circumferentially along the grooves 21e without interfering with each other on the inside, so the aperture blades 23 can be driven open and closed without any problem.

The recess 22g is a recess in the optical axis X direction provided in the main body part 22a opposite the base plate 21 along the portion where the gear portion 22c is provided, in order to form the teeth of the gear portion 22c, and has an escape shape in the optical axis X direction to ensure a space for assembling and disposing the drive gear 24a of the drive motor 24. Providing the recess 22g allows the space in the optical axis X direction between the base plate 21 and the drive ring 22 to be wider than in other portions.

The recess 22g has a shape in which the surface of the main body part 22a on the image plane side is recessed at least by the tooth width of the gear portion 22c toward the subject side in the optical axis X direction and further back than (away from) the position of the distal end of the drive gear 24a in the optical axis X direction so that the drive gear 24a meshed with the gear portion 22c will not interfere with the drive ring 22 even when the drive ring 22 rotates relative to the base plate 21 within the range of the usage state (light amount adjustable state) of the aperture unit 20, that is, from the maximum aperture position (the state in FIG. 9) to the minimum aperture position (the state in FIG. 10), and furthermore has an escape shape that spreads out circumferentially in an approximate fan shape when viewed in the optical axis X direction.

At the rotational angle position of the drive ring 22 relative to the base plate 21, if an attempt is made to attach the drive motor 24 to the base plate 21 at an angular position at which the recess 22g is not disposed directly in front of the through-hole 21ca of the base plate 21 in the optical axis X direction, the drive gear 24a and the main body part 22a of the drive ring 22 will interfere with each other in the optical axis X direction, making it impossible to attach the drive motor 24 to the attachment portion 21c of the base plate 21. Therefore, when attaching the drive motor 24 to the base plate 21, the rotation angle position of the drive ring 22 relative to the base plate 21 must be an angle position at which the recess 22g is located directly in front of the through-hole 21ca of the attachment portion 21c in the optical axis X direction. In other words, when the drive ring 22 is in the assembled state of the aperture unit 20 relative to the base plate 21 (from the assembly start position to the assembly completion position), that is, in the state shown in FIG. 8, the recess 22g is not present (is not disposed) in front (in the optical axis X direction) of the through-hole 21ca into which the drive gear 24a is fitted, and when the drive ring 22 rotates relative to the base plate 21 to the state shown in FIG. 9, that is, to the assembly completion position (bayonet assembly completion position, bayonet coupling position, maximum aperture position), the recess 22g turns (is disposed) to be in front of the through-hole 21ca. As a result, the drive motor 24 cannot be attached to the attachment portion 21c of the base plate 21 in the state shown in FIG. 8, but can be attached in the state shown in FIG. 9.

In this embodiment, the drive motor 24 is attached to the base plate 21 when the rotation angle position of the drive ring 22 relative to the base plate 21 is in the state shown in FIG. 9. This rotation angle position is the assembly completion position (bayonet assembly completion position, bayonet coupling position, maximum aperture position).

The drive gear 24a and the gear portion 22c must have a specific meshing tooth width in order to ensure strength when transmitting the drive force.

The recess 22g has a shape that widens in the optical axis X direction so that the drive gear 24a and the gear portion 22c can form the gear tooth width that is needed to ensure the required strength.

The recess 22g has two side walls 22ga and 22gb, which are formed extending in the radial direction centered on the optical axis X and are in contact with the drive gear 24a.

In the state of FIG. 9 in which the drive motor 24 is attached to the base plate 21, that is, when the drive ring 22 is rotated from the assembly completion position (bayonet assembly completion position, bayonet coupling position, maximum aperture position) by a specific angle relative to the base plate 21 in the direction of FIG. 8, that is, in the assembly start position direction (counterclockwise in FIG. 9), the side wall 22ga of the recess 22g hits the drive gear 24a and cannot rotate any further in the assembly start position direction (counterclockwise in FIG. 9). In this state, the drive ring 22 will not come off from the base plate 21, that is, will not come apart. Consequently, the side wall 22ga defines one end (first mechanical end) of the drive range that sets the usable state (light amount adjustable state) in the rotation direction of the drive ring 22 relative to the base plate 21. In this embodiment, this first mechanical end defines the drive range end on the maximum aperture side (open aperture side) in the light amount adjustable region.

Thus, attaching the drive motor 24 to the base plate 21 prevents the drive ring 22 from rotating around the optical axis X relative to the base plate 21 to the state shown in FIG. 8, that is, to the assembly start position (bayonet assembly start position, bayonet tab insertion position). That is, when viewed in the optical axis X direction, the positions of the three insertion portions 22da on the drive ring 22 side cannot rotate to the positions of the three tabs 21d on the base plate 21 side, so the three tabs 21d will not be separated from the three insertion portions 22da (the bayonet coupling will not be released). As a result, this prevents the aperture unit 20 from coming apart.

When the drive ring 22 is further rotated from the state in FIG. 10, that is, from the minimum aperture position, by a specific angle relative to the base plate 21 in the direction from FIG. 9 to FIG. 10, that is, in the direction from the maximum aperture position to the minimum aperture position (clockwise in FIG. 10), the side wall 22gb of the recess 22g hits the drive gear 24a and cannot rotate any further in the direction from the maximum aperture position to the minimum aperture position (clockwise in FIG. 10). Consequently, the side wall 22gb defines one end (second mechanical end) of the drive range that sets the usable state (light amount adjustable state) in the rotation direction of the drive ring 22 relative to the base plate 21. In the case of this embodiment, this second mechanical end defines the drive range end on the minimum aperture side (small aperture side) in the light amount adjustable region.

That is, when the drive motor 24 is rotationally driven while attached to the base plate 21, the drive ring 22 rotates around the optical axis X relative to the base plate 21, and the drive gear 24a of the drive motor 24 fixed on the base plate 21 side moves relatively within a range from the side wall 22ga (first mechanical end) to the side wall 22gb (second mechanical end) of the recess 22g provided on the drive ring 22 side (actually, the recess 22g moves in the circumferential direction relative to the drive gear 24a), and both ends of the rotational drive range centered on the optical axis X are defined by the side wall 22ga (first mechanical end) and the side wall 22gb (second mechanical end) which extend in the radial direction centered on the optical axis X, which are the surfaces of the ends of the recess 22g.

Consequently, the drive gear 24a moves relatively in the circumferential direction centered on the optical axis X (actually, the recess 22g moves in the circumferential direction relative to the drive gear 24a) within the drive range that sets the usable state (light amount adjustable state) defined by the recess 22g (within the range from the side wall 22ga (first mechanical end) to the side wall 22gb (second mechanical end)), thereby allowing the drive gear 24a to function as a stopper that defines the rotatable range of the drive ring 22 relative to the base plate 21.

In this embodiment, the connection method for transmitting the rotation of the drive motor 24 (the drive source) to the drive ring 22 was gear coupling between the drive gear 24a (the rotational drive transmission unit) and the gear portion 22c (the rotation connection part), but this is not the only option. The connection method may instead be friction coupling produced by pressing between an elastic roller (the rotational drive transmission unit) and the inner peripheral surface of the circumferential wall on the outer peripheral side of the drive ring 22 (the rotation connection part). The rotational drive transmission unit may be anything that rotates in conjunction with the drive motor 24 and contacts and connects with a part of the drive ring 22 to transmit rotation or rotational drive force from the drive motor 24 to the drive ring 22, and this has the same effect as in this embodiment.

Also, in this embodiment, the drive gear 24a attached to the drive motor 24 was used as the stopper, but this is not the only option. So long as the component is integral with part of the outer shape of the drive motor 24 itself, or with a screw or metal fitting for attaching the drive motor 24, that is, with the drive motor 24, and has a shape that is convex on the recess 22g side in the optical axis X direction and can make contact with the side wall 22ga or 22gb, such a component will have the same effect as the stopper in this embodiment.

Also, in this embodiment, the stopper is defined by the two ends of the recess 22g, that is, by the side wall 22ga and the side wall 22gb, but this is not the only option. Just one of these, such as just the side wall 22ga side (the maximum aperture side, the bayonet assembly start side, the bayonet tab insertion side) may be used as the stopper. In this case, the other stopper (the opposite side from the minimum aperture side, the bayonet assembly start side, and the bayonet tab insertion side) may, for example, be a circumferential contact part formed on the tab 21d and the latching portion 22db, which are the bayonet coupling portion between the base plate 21 and the drive ring 22, or may be a circumferential contact part formed on the grooves 21e of the base plate 21 and the cam followers 22f of the drive ring 22, or may be a circumferential contact part formed on the rotation shafts 21f of the base plate 21 and the grooves 22e of the drive ring 22, and these will have the same effect as the stopper in this embodiment.

### (2-3) Aperture Blades 23

As shown in FIGS. 2 and 3, the aperture blades (movable blades) 23 are disposed in a space formed in a substantially constant size extending in the optical axis X direction and in the radial direction relative to the optical axis X between the base plate 21 and the drive ring 22 arranged in the optical axis X direction. To describe this in more detail, the outer shape of the aperture unit 20 of a first side in optical axis X direction is constituted by some or all of the base plate 21, and the outer shape of a second side opposite to the first side in the optical axis X direction is constituted by some or all of the drive ring 22, and the aperture blades (movable blades) 23 are disposed in a space formed between the two and with a substantially constant size extending in the optical axis X direction and in the radial direction relative to the optical axis X. Furthermore, in the aperture unit 20, when the aperture blades 23 are being opened or closed, the rotation shafts 21f, the cam followers 22f, and the cam slots 23d are disposed to overlap the base plate 21 when viewed in the optical axis X direction. Also, the rotation shafts 21f, the cam followers 22f, and the cam slots 23d overlap the drive ring 22 when viewed in the optical axis X direction in a state in which the aperture blades 23 are being opened or closed. In other words, when the aperture blades 23 are being opened or closed, the base plate 21 and the drive ring 22 have a size or shape that covers the rotation shafts 21f, the cam followers 22f, and the cam slots 23d so as to sandwich them from both the subject side and the image plane side in the optical axis direction. Accordingly, the operation of the cam mechanism for rotating the aperture blades 23, which is made up of the rotation shafts 21f, the cam followers 22f, and the cam slots 23d, is not hindered. Also, the multiple aperture blades (movable blades) 23 will not come off the aperture unit 20 in the optical axis X direction even when driven rotationally for an opening or closing operation. Within this space, the aperture blades 23 are driven open or closed by rotating around the rotation shafts 21f (see FIG. 4) provided to the base plate 21 by a known cam mechanism consisting of the cam followers 22f and the cam slots 23d in response to the rotation of the drive ring 22 relative to the base plate 21. As a result, the aperture blades (movable blades) 23 change the size (surface area) of the opening (third opening) 23b (see FIG. 3, etc.) to adjust the amount of light that passes through the opening of the aperture unit 20.

More precisely, as shown in FIGS. 6A and 6B, the aperture blades 23 each have a blade portion 23a, a through-hole 23c, a cam slot 23d, and a tip portion 23e.

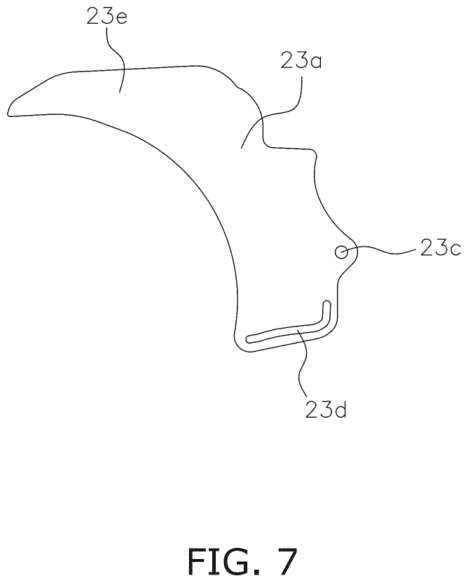

As shown in FIG. 7, the blade portion 23a is a plate-like member formed in a blade shape.

The through-hole 23c passes through the blade portion 23a in the thickness direction, and a rotation shaft 21f (see FIG. 4, etc.) provided to the base plate 21 is inserted into this. Consequently, the aperture blades 23 rotate around the rotation shafts 21f inserted into the through-holes 23c.

As shown in FIG. 7, the cam slot 23d is formed near the end on the through-hole 23c side into which the rotation shaft 21f is inserted, and on the opposite side of the through-hole 23c from the tip portion 23e, and passes through the blade portion 23a in the thickness direction. When the drive ring 22 is rotated, the cam followers 22f (see FIG. 5, etc.) move in the circumferential direction around the optical axis X. Consequently, the force produced by the cam followers 22f from the circumferential direction acts as a rotational drive force on the cam slots 23d into which the cam followers 22f are inserted. The result is that the aperture blades 23 are rotated around the rotation shafts 21f by a known cam mechanism, thereby opening or closing the aperture opening.

When the drive ring 22 rotates relative to the base plate 21 from the assembly start position to the assembly completion position (maximum throttle position) and from the assembly completion position (bayonet assembly completion position, bayonet coupling position, maximum throttle position) to the minimum throttle position, the cam followers 22f also rotate relative to the base plate 21 by the same angle, that is, move in the circumferential direction. Therefore, the cam slots 23d have a length that is long enough that even if the drive ring 22 rotates relative to the base plate 21 by approximately the rotation angle from the assembly start position, through the assembly completion position (bayonet assembly completion position, bayonet coupling position, maximum throttle position), and to the minimum throttle position, the ends of the cam slots 23d (the end in the direction in which the cam follower 22f moves relatively inside the cam slot 23d) will not interfere with the cam followers 22f even if the cam followers 22f move in the approximately circumferential direction.

Consequently, even if the drive ring 22 rotates around the optical axis X relative to the base plate 21 in the assembled state and in the usage state (light amount adjustment state), the cam followers 22f on the drive ring 22 side can move along the inside of the cam slots 23d without their movement being restricted by the ends of the cam slots 23d in the direction in which the cam followers 22f move relatively. As a result, in the assembled state and in the usage state (light amount adjustment state), the cam followers 22f can move in a substantially circumferential direction around the optical axis without their movement being restricted by the cam slots 23d, so the aperture blades 23 can be opened and closed without hindrance.

That is, even if the base plate 21 and the drive ring 22 rotate relatively around the optical axis X in their assembled state, the base plate 21 will not restrict the rotation of the drive ring 22.

As shown in FIG. 7, the tip portion 23e is a part of the blade portion 23a, and is the tip portion on the free end side on the opposite side from where the cam slot 23d is located relative to the through-hole 23c, and is a portion where the width gradually narrows moving away from the through-hole 23c as viewed in the optical axis X direction.

The mechanism for opening and closing the nine aperture blades 23 in the aperture unit 20 of this embodiment will now be described.

As discussed above, with the aperture unit 20 of this embodiment, the nine aperture blades 23 rotate around their respective rotation shafts 21f, thereby changing the surface area of the opening (third opening) 23b formed in the center portion of the substantially circular ring formed by the nine aperture blades 23, that is, at the center of the optical axis X, as shown in FIGS. 6A and 6B.

More specifically, when the cam followers 22f of the drive ring 22 are inserted into the cam slots 23d of the nine aperture blades 23 and the drive ring 22 is rotationally driven relative to the base plate 21, the nine aperture blades 23 are rotated by a known cam mechanism counterclockwise around the through-holes 23c into which the rotation shafts 21f are inserted, from a state in which adjacent aperture blades 23 overlap, as shown in FIG. 6A.

The tip portions 23e of aperture blades 23 then gradually advance toward the optical axis X (the inside diameter side centered on the optical axis X). When the drive ring 22 is further rotated, the aperture blades 23 further rotate counterclockwise, and the size (surface area) of the aperture opening (opening (third opening) 23b) becomes smaller, as shown in FIG. 6B.

This allows the surface area of the aperture opening to be adjusted between the maximum aperture (fully open, maximum opening) state shown in FIG. 6A and the minimum aperture (minimum opening) state shown in FIG. 6B.

Assembly of Aperture Unit 20 (from Assembly Start to Assembly Completion)

First, the aperture blades 23 are attached to the base plate 21 from the optical axis X direction. More specifically, the rotation shafts 21f of the base plate 21 in the state shown in FIG. 4 are inserted into the through-holes 23c of the aperture blades 23 one by one, and the nine aperture blades 23 are overlapped so as to be in their maximum aperture state (the state in FIG. 6A).

Next, the drive ring 22 is attached from above in the optical axis X direction to the base plate 21 to which the nine aperture blades 23 are attached in the maximum aperture state (the state in FIG. 6A).

With the aperture unit 20 of this embodiment, bayonet coupling is employed, which makes it easy to detach and attach the base plate 21 and the drive ring 22 when performing assembly and disassembly so that the base plate 21 and the drive ring 22 are rotatable around the optical axis X, but are immovable (substantially integrated) in the optical axis X direction after assembly is complete (during use).

Therefore, in mounting the drive ring 22 to the base plate 21, it is necessary to attach a bayonet coupling portion, and the specific attachment method for this will be now described.

First, in the assembly start position shown in FIG. 8 (bayonet assembly start position, bayonet tab insertion position), the positions of the three tabs 21d on the base plate 21 side and the positions of the three insertion portions 22da on the drive ring 22 side are aligned as viewed in the optical axis X direction. That is, the angular positions of the three tabs 21d and the angular positions of the three insertion portions 22da are aligned as centered on the optical axis X.

At this time, the drive motor 24 has yet to be attached to the attachment portion 21c on the base plate 21 side.

Next, from this state, the drive ring 22 is moved in the optical axis X direction (perpendicular to the drawing plane in FIG. 8) relative to the base plate 21, and the drive ring 22 is brought into contact with the base plate 21 in the optical axis X direction. In this state in FIG. 8, that is, at the assembly start position (bayonet assembly start position, bayonet tab insertion position), when the drive ring 22 is brought into contact with the base plate 21 in the optical axis X direction, the grooves 22e of the drive ring 22 are disposed extending in the circumferential direction centered on the optical axis X so as to be in front of the rotation shafts 21f in the optical axis X direction so that the rotation shafts 21f of the base plate 21 and the main body part 22a of the drive ring 22 will not interfere with each other. Also, in the state in FIG. 8, the grooves 21e of the base plate 21 are disposed extending in the circumferential direction centered on the optical axis X so as to be in front of the cam followers 22f in the optical axis X direction so that the cam followers 22f of the drive ring 22 and the main body part 21a of the base plate 21 will not interfere with each other. Furthermore, in the state in FIG. 8, the cam slots 23d are disposed extending so as to be in front of the cam followers 22f in the optical axis X direction when the aperture blades 23 are in their maximum aperture state (the state in FIG. 6A) so that the cam followers 22f of the drive ring 22 and the blade portions 23a of the aperture blades 23 will not interfere with each other. This extended portion of the cam slots 23d is a path disposed in the circumferential direction around the optical axis X when the aperture blades 23 are in their maximum aperture position state (the state in FIG. 6A), or in other words, a path in the same direction (relative angle of approximately) 0° as the cam followers 22f moving in the circumferential direction around the optical axis X, so the aperture blades 23 are not driven open or closed even if the drive ring 22 rotates relative to the base plate 21 in this region. In other words, this extended portion of the cam slots 23d is a path in which the opening or closing operation (rotation operation) of the aperture blades 23 is insensitive (non-operating state) to the rotation of the drive ring 22 relative to the base plate 21.

Thus, the drive ring 22 can be brought into contact with the base plate 21 in the optical axis X direction in the state shown in FIG. 8, that is, in the assembly start position (bayonet assembly start position, bayonet tab insertion position), without the base plate 21, drive ring 22, and aperture blades 23 interfering with each other.

As shown in FIG. 8, the through-hole 21ca for attaching the drive motor 24 does not entirely overlap the substantially arc-shaped recess 22g provided on the drive ring 22 side when viewed in the optical axis X direction. In other words, the through-hole 21ca at least partially overlaps the main body part 22a of the drive ring 22 other than the recess 22g when viewed in the optical axis X direction. If an attempt is made to attach the drive motor 24 to the attachment portion 21c of the base plate 21 in this state, the drive gear 24a will interfere with the main body part 22a, and therefore the drive motor 24 cannot be attached to the attachment portion 21c of the base plate 21 in the state shown in FIG. 8, that is, at the assembly start position.

Next, the drive ring 22 is rotated clockwise from the state shown in FIG. 8. When this happens, part of the tabs 21d of the base plate 21 goes into the lower side of the latching portion 22db of the drive ring 22 in the direction perpendicular to the drawing plane in FIG. 9, and goes into the gap between the latching portions 22db and the surface of the main body part 22a that is opposite the base plate 21, that is, the bayonet groove 22dd. As a result, as shown in FIG. 9, the tabs 21d and the latching portions 22db form latched portions (minimum) A1, which are portions where these two overlap as viewed in the optical axis X direction, at three locations at approximately equal angular intervals around the optical axis X in the circumferential direction (rotation angle direction), resulting in a state of the assembly completion position (bayonet assembly completion position, bayonet coupling position). The latched portions (minimum) A1 have a width at which the latching portions 22db press (cover) the tabs 21d in the optical axis X direction, and therefore have a size (length) sufficient to ensure good coupling strength between the base plate 21 and the drive ring 22 in the optical axis X direction.

Consequently, the base plate 21 and the drive ring 22 are substantially integrated (substantially immobile) so as not to come apart in the optical axis X direction, and are latched in a state in which they can rotate relatively around the optical axis X, that is, a bayonet coupling state.

That is, when the base plate 21 and the drive ring 22 are assembled together, such as when the aperture blades 23 are in their maximum aperture state, as shown in FIG. 9, the tabs 21d of the base plate 21 go into the bayonet grooves 22dd below the latching portions 22 db of the drive ring 22 in a direction perpendicular to the drawing plane in FIG. 9, and the drive ring 22 and the base plate 21 become unable to move relatively in the optical axis X direction.

At this time, the drive ring 22 is positioned such that the tabs 21d of the base plate 21 go down into the bayonet grooves 22dd under the latching portions 22db of the drive ring 22, which restricts movement in the optical axis X direction. In other words, the drive ring 22 is held by the base plate 21 in a state of being rotatable around the optical axis X while being restricted from moving in the optical axis X direction.

Consequently, the drive ring 22 is attached to the base plate 21 while maintaining a state of being able to rotate around the optical axis X within a specific range from the assembly start position or a position rotated a certain amount toward the assembly completion position from the assembly start position.

Even in the state in FIG. 9, that is, in the assembly completion position (bayonet assembly completion position, bayonet tab coupling position), as in the state in FIG. 8, the grooves 22e of the drive ring 22 are disposed in front of the rotation shafts 21f in the optical axis X direction so that the rotation shafts 21f of the base plate 21 will not interfere with the main body part 22a of the drive ring 22. Also, as in the state in FIG. 8, the grooves 21e of the base plate 21 are disposed in front of the cam followers 22f in the optical axis X direction so that the cam followers 22f of the drive ring 22 will not interfere with the main body part 21a of the base plate 21. Furthermore, in the state in FIG. 9, in order to drive the aperture blades 23 open and closed (rotational drive), the cam slots 23d of the aperture blades 23 are disposed in front of the cam followers 22f of the drive ring 22 in the optical axis X direction, and are latched when the cam followers 22f pass therethrough.

Even if the drive ring 22 rotates relative to the base plate 21 from the state in FIG. 8 to the state in FIG. 9, as described above, the position and open/closed state of the aperture blades 23 will not change from the state in FIG. 8, and the maximum aperture state (fully open, maximum opening state) is maintained.

The path of the cam slots 23d from the state in FIG. 9 to the state in FIG. 10 has a shape that follows along a direction obtained by adding a specific angle to the circumferential direction centered on the optical axis X (circumferential direction+specific angle direction), in other words, an angle direction between the radial direction and the circumferential direction centered on the optical axis, in order to rotationally drive the aperture blades 23. When the drive ring 22 rotates relative to the base plate 21 in this region, the aperture blades 23 are rotationally driven open or closed by rotating around the rotation shafts 21f by a cam mechanism including the cam slots 23d having a specific angle relative to the circumferential direction centered on the optical axis X, and the cam followers 22f that move in the circumferential direction centered on the optical axis X.

Thus, even in the state in FIG. 9, the drive ring 22 can be rotated relative to the base plate 21 without the base plate 21, the drive ring 22, and the aperture blades 23 interfering with each other.

The circumferential direction (rotation angle direction) dimension of the latched portions (minimum) A1 is set to a length greater than or equal to what is required to ensure good strength when the tabs 21d of the base plate 21 and the latching portions 22db of the drive ring 22 are coupled.

As the final step in the assembly of the aperture unit 20, the drive motor 24 is attached to the base plate 21. In order to attach the drive motor 24 to the attachment portion 21c of the base plate 21, the drive gear 24a needs to be passed through the through-hole 21ca. In the state in FIG. 9, the through-hole 21ca entirely overlaps the substantially arc-shaped recess 22g provided on the drive ring 22 side when viewed in the optical axis X direction. In other words, the through-hole 21ca does not overlap the main body part 22a of the drive ring 22 other than the recess 22g. In the state in FIG. 9, that is, in the assembly completion position (bayonet assembly completion position, bayonet coupling position, maximum aperture position) state, if an attempt is made to attach the drive motor 24 to the attachment portion 21c of the base plate 21, the drive gear 24a will not interfere with the side wall 22ga, which is the end portion extending in the radial direction centered on one optical axis X of the recess 22g, and therefore the drive gear 24a can be inserted into the through-hole 21ca, and the drive motor 24 can be attached to the attachment portion 21c of the base plate 21.

When the drive ring 22 is rotated relative to the base plate 21 by a specific angle in the direction of FIG. 8, that is, the assembly start position direction (counterclockwise in FIG. 9) from the state in FIG. 9 in which the drive motor 24 is attached to the base plate 21, that is, from the assembly completion position (bayonet assembly completion position, bayonet coupling position, maximum aperture position), the side wall 22ga of the recess 22g hits the drive gear 24a and cannot rotate any further in the assembly start position direction (counterclockwise in FIG. 9). In this state, the drive ring 22 will not come off from the base plate 21, that is, will not come apart. This defines one end (first mechanical end) of the drive range that sets the usable state (light amount adjustable state) in the rotation direction of the drive ring 22 relative to the base plate 21. In this embodiment, this first mechanical end defines the drive range end on the maximum aperture side (open aperture side) in the light amount adjustable region.

Thus, after the state shown in FIG. 9, that is, the rotation angle position of the base plate 21 and the drive ring 22, has been brought to the assembly completed state (bayonet assembly completed state), the drive gear 24a is attached near the side wall 22ga, which is one end of the substantially arc-shaped recess 22g provided on the drive ring 22 side, thereby defining the end of the range of relative rotation between the base plate 21 and the drive ring 22, such as the drive range end on the maximum aperture side (open aperture side) in the light amount adjustable region.

When the drive ring 22 is rotated relative to the base plate 21 in the direction toward FIG. 8 (counterclockwise in FIG. 9), that is, toward the assembly start position (bayonet assembly start position, bayonet tab insertion position) in a state in which the drive motor 24 has been removed from the base plate 21 in the state of FIG. 9, that is, in the assembly completion position (bayonet assembly completion position, bayonet coupling position, maximum aperture position), there is no place where there is contact between the base plate 21 and the drive ring 22 in the rotation direction (circumferential direction), so the drive ring 22 can rotate to the assembly start position (bayonet assembly start position, bayonet tab insertion position, position in FIG. 8). At the assembly start position, as discussed above, the positions of the tabs 21d of the base plate 21 and the insertion portions 22da of the drive ring 22 line up when viewed in the optical axis X direction, so in this state the drive ring 22 comes off from the base plate 21. That is, the aperture unit 20 comes apart. Therefore, except when the aperture unit 20 is intentionally taken apart from the assembly completed state, as long as the drive motor 24 is attached to the base plate 21, the aperture unit 20 will not come apart even if an error occurs in the rotation control of the drive motor 24 during use and the rotational position of the drive ring 22 moves too far relative to the base plate 21 and goes all the way to the drive end defined by the mechanical end.

When the aperture unit 20 is to be intentionally taken apart from the assembly completed state, first the drive motor 24 is removed from the base plate 21, after which the drive ring 22 is rotated relative to the base plate 21 in the direction toward FIG. 8 (counterclockwise in FIG. 9) until it reaches the assembly start position (bayonet assembly start position, bayonet tab insertion position), which will return the bayonet coupling portion to the bayonet assembly start state, so the drive ring 22 can be removed from the base plate 21 and the aperture unit 20 can be taken apart.

In the state shown in FIG. 8, the rotation shafts 21f engaged with the grooves 22e are disposed at positions slightly more to the inside than the ends of the grooves 22e. Consequently, at the start of assembly of the base plate 21 and the drive ring 22 shown in FIG. 8, a space in which the rotation shafts 21f will be disposed can be formed in the grooves 22e. Similarly, in the state shown in FIG. 8, the cam followers 22f engaged with the grooves 21e are disposed at positions slightly more to the inside than the ends of the grooves 21e. Consequently, at the start of assembly of the base plate 21 and the drive ring 22 shown in FIG. 8, a space in which the cam followers 22f will be disposed can be formed in the grooves 21e.

Also, in the state shown in FIG. 9, the drive gear 24a engaged with the gear portion 22c of the drive ring 22 is disposed at a position further to the inside than the side wall 22ga, which is the end of the recess 22g. Consequently, in the positional relationship between the base plate 21 and the drive ring 22 shown in FIG. 9, a space for disposing the drive gear 24a can be formed in the recess 22g when the drive motor 24 is attached to the base plate 21.

Light Amount Adjustment of Aperture Unit 20 (from Maximum Aperture to Minimum Aperture)

When the drive ring 22 is further rotated by the drive motor 24 from the state shown in FIG. 9 toward the side where the aperture opening (third aperture 23b) is closed, that is, the minimum aperture side, the state shown in FIG. 10 is reached.

In the state in FIG. 10, that is, at the minimum aperture position (minimum opening position), just as in the state in FIG. 9, the grooves 22e of the drive ring 22 are disposed in front of the rotation shafts 21f in the optical axis X direction so that the rotation shafts 21f of the base plate 21 will not interfere with the main body part 22a of the drive ring 22. Also, as in the state in FIG. 9, the grooves 21e of the base plate 21 are disposed in front of the cam followers 22f in the optical axis X direction so that the cam followers 22f of the drive ring 22 will not interfere with the main body part 21a of the base plate 21. Furthermore, in the state in FIG. 10, in order to drive (rotate) the aperture blades 23 open or closed, the cam slots 23d of the aperture blades 23 are disposed in front of the cam followers 22f of the drive ring 22 in the optical axis X direction, and the cam followers 22f pass through and engaged with the cam slots 23d.

As described above, the path of the cam slots 23d from the state in FIG. 9 to the state in FIG. 10 has a shape that follows along a direction obtained by adding a specific angle to the circumferential direction centered on the optical axis X (circumferential direction+specific angle direction), or in other words, an angle direction between the radial direction and the circumferential direction centered on the optical axis, and when the drive ring 22 rotates relative to the base plate 21, the aperture blades 23 are driven open or closed.

Thus, even in the state shown in FIG. 10, the drive ring 22 can be rotated relative to the base plate 21 without the base plate 21, drive ring 22, and aperture blades 23 interfering with each other.

At this time, as shown in FIG. 10, the tabs 21d on the base plate 21 side go in on the lower side in a direction perpendicular to the drawing plane on the drive ring 22 side, and are positioned in gaps between the latching portions 22db and the surface of the main body part 22a opposite the base plate 21, that is, in the bayonet groove 22dd. The tabs 21d and the latching portions 22db form latched portions (maximum) A2, which are portions where the two overlap as viewed in the optical axis X direction, at three locations at approximately equal angular intervals around the optical axis X in the circumferential direction (rotation angle direction). The latched portions (maximum) A2 have a width at which the latching portions 22db press (cover) the tabs 21d in the optical axis X direction, so the greater is the width, the higher is the coupling strength between the base plate 21 and the drive ring 22 in the optical axis X direction. Since the circumferential (rotation angle direction) dimension of the latched portions (maximum) A2 is greater than that of the latched portions (minimum) A1, the strength of the connection between the tabs 21d of the base plate 21 and the latching portions 22db of the drive ring 22 is not problematic.

Consequently, even if the drive ring 22 is rotated to the minimum aperture end (minimum opening end) after the drive ring 22 is attached to the base plate 21, the drive ring 22 and the base plate 21 will not come apart in the optical axis X direction.

When the drive ring 22 is rotated by a specific angle relative to the base plate 21 from the state in FIG. 10 (minimum aperture position) in the direction from FIG. 9 to FIG. 10, that is, in the direction from the maximum aperture position to the minimum aperture position (clockwise in FIG. 10), the drive gear 24a of the drive motor 24 hits the side wall 22gb, which is the end of the recess 22g on the drive ring 22 side.

As shown in FIGS. 8 to 10, with the aperture unit 20 of this embodiment, the gear portion 22c on the drive ring 22 side and the drive gear 24a, which is the rotational drive transmission unit of the drive motor 24 fixed to the base plate 21 side, are disposed so as to engage with each other further to the outside in the radial direction centered on the optical axis X than one or more of the aperture blades 23. In other words, at least a part of the engagement portion between the drive gear 24a, which is a rotational drive transmission unit, and the gear portion 22c is disposed more to the outside diameter side centered on the optical axis X than the range in which one or more of the aperture blades 23 operate by opening or closing drive, and close to one or more of the aperture blades 23, that is, in the case of this embodiment, is disposed more to the outside diameter side centered on the optical axis X than the outer shape portion of one or more of the aperture blades 23 at the maximum aperture position, and close to one or more of the aperture blades 23.

Consequently, the range in which the aperture blades 23 rotate and the engagement portion between the gear portion 22c and the drive gear 24a, which is the rotational drive transmission unit, do not overlap when viewed in the optical axis X direction, so malfunction caused by mutual interference is avoided and there is less of an increase in the size in the radial direction perpendicular to the optical axis X, and eliminating one of the three annular members, namely, the first frame body (base plate), the second frame body (drive ring), and the third frame body (cover), which were necessary with a conventional aperture unit configuration, prevents an increase in size in the optical axis X direction, allowing the drive ring 22 to be rotationally driven. As mentioned above, the same effect can be obtained by applying the rotation shaft of the drive motor 24 as one of the rotational drive transmission units and disposing the rotation shaft more to the outside diameter side centered on the optical axis X than the range in which one or more of the aperture blades 23 operate by opening or closing drive, and close to one or more of the aperture blades 23.

Also, as shown in FIG. 5, the gear portion 22c is disposed on the inside diameter surface (inner peripheral surface) of the outer peripheral wall 22dc on the outermost side (outside diameter side) of the main body part 22a of the drive ring 22 centered on the optical axis X.

Consequently, disposing the gear portion 22c at a position more to the outside in the radial direction than the range in which one or more of the aperture blades 23 rotate prevents interference between the gear portion 22c and rotational drive transmission units such as the drive gear 24a that transmits the rotational force of the drive motor 24 to the gear portion 22c, and one or more of the aperture blades 23, while ensuring as large a space as possible in which the aperture blades 23 can move, and also suppressing an increase in the size in the radial direction perpendicular to the optical axis X. In addition, eliminating one of the three annular members, namely, the first frame body (base plate), second frame body (drive ring), and third frame body (cover), which were necessary in the configuration of a conventional aperture unit, avoids an increase in size in the optical axis X direction, and the drive ring 22 can be rotationally driven.

Also, in this embodiment, the recess 22g on the drive ring 22 hits the drive gear 24a at the two substantially arc-shaped ends (the side walls 22ga and 22gb), thereby defining the range of relative rotation between the base plate 21 and the drive ring 22.

Consequently, by making the drive gear 24a function as a stopper member for defining the range of relative rotation between the base plate 21 and the drive ring 22, the base plate 21 can be prevented from coming off the drive ring 22 in the optical axis X direction while defining the usage range of the aperture unit 20. Furthermore, since no separate stopper member need be provided, fewer parts are required. As discussed above, as long as the stopper is integral with part of the outer shape of the drive motor 24, or with a screw or metal fitting for attaching the drive motor 24, that is, with the drive motor 24, and has a shape that protrudes on the recess 22g side in the optical axis X direction and can make contact with the side wall 22ga or 22gb, such a component will have the same effect as the stopper in this embodiment. Also, as mentioned above, if just one of the ends of the recess 22g, such as just the side wall 22ga side (the maximum aperture side, the bayonet assembly start side, the bayonet tab insertion side) is used as a stopper, and the other stopper (the minimum aperture side, the bayonet assembly start side, the opposite side to the bayonet tab insertion side) is used by forming a circumferential direction contact portion on the tabs 21d and the latching portions 22db, which are the bayonet connection portions between the base plate 21 and the drive ring 22, then the same effect as in this embodiment can be achieved as a stopper.

Furthermore, with the aperture unit 20 of this embodiment, the latching length in the circumferential direction centered on the optical axis X between the base plate 21 and the drive ring 22, which are latched together by bayonet coupling, is at its minimum when the aperture blades 23 are in the maximum aperture state (fully open, maximum opening, assembly completed) (see FIG. 9), and at its maximum when the aperture blades 23 are in the minimum aperture state (fully closed) (see FIG. 10).

Here, when the base plate 21 is rotated by a specific angle relative to the drive ring 22 in a direction in which the latching length becomes even shorter from the maximum aperture position (assembly completed position) where the latching length of the bayonet coupling is at its minimum, that is, in the direction from FIG. 9 to FIG. 8 (counterclockwise in FIG. 9), the drive gear 24a hits the side wall 22ga, which is the end of the recess 22g, at a position just ahead of where the latching length reaches zero, thereby restricting the rotation of the base plate 21.

Also, with the aperture unit 20 of this embodiment, when the aperture blades 23 are being opened or closed, the rotation shafts 21f, the cam followers 22f, and the cam slots 23d are disposed so as to overlap the drive ring 22 when viewed from the opposite side of the base plate 21 in the optical axis X direction. In other words, when the aperture blades 23 are being opened or closed, the main body part 22a of the drive ring 22 has a size or shape that covers at least the rotation shafts 21f, the cam followers 22f, and the cam slots 23d when viewed in the optical axis X direction. As a result, the drive ring 22, which constitutes some or all of one external shape of the aperture unit 20 in the optical axis X direction, can cover the rotation shafts 21f, the cam followers 22f, and the cam slots 23d from the opposite side of the base plate 21 in the optical axis X direction, so that there is no interference with the cam mechanism for rotating the aperture blades 23 open or closed.

Furthermore, with the aperture unit 20 of this embodiment, the drive gear 24a, which is the rotational drive transmission unit, is disposed so as to overlap the drive ring 22 when viewed from the opposite side of the base plate 21 in the optical axis X direction. In other words, the main body part 22a of the drive ring 22 has a size or shape that covers at least the drive gear 24a, which is the rotational drive transmission unit, when viewed in the optical axis X direction. As a result, the drive ring 22, which constitutes some or all of the outer shape of the aperture unit 20 of the first side in the optical axis X direction, can cover the drive gear 24a, which is the rotational drive transmission unit, from the opposite side of the base plate 21 in the optical axis X direction, so that any clinging dust, foreign matter, or the like will not interfere with the rotational drive of the drive gear 24a.

This allows the aperture blades 23 to be driven open or closed within a range overlapping with the drive ring 22 when viewed in the optical axis X direction.

Furthermore, with the aperture unit 20 of this embodiment, the outer shape of a first side in optical axis X direction is constituted by some or all of the base plate 21, and the outer shape of a second side opposite to the first side in the optical axis X direction is constituted by some or all of the drive ring 22. In other words, the outer shape of the first side in the optical axis X direction is constituted by some or all of the base plate 21, and the outer shape of the second side opposite to the first side in the optical axis X direction is constituted by some or all of the drive ring 22. When the aperture blades 23 are in a state of being opened or closed, the base plate 21 and the drive ring 22 have a shape that partially or completely covers the aperture blades 23 so as to sandwich them partially or completely from both the subject side and the image plane side in the optical axis direction. Therefore, the aperture blades 23 will not come off of the aperture unit 20 even if they are rotationally driven open or closed. Thus, one of the three annular components, namely, the first frame body (base plate), the second frame body (drive ring), and the third frame body (cover), which were necessary in the configuration of a conventional aperture unit, can be eliminated without causing any problems, and the size of the aperture unit in the optical axis X direction can be reduced.

### Main Features

As shown in FIG. 2, the aperture unit 20 of this embodiment includes the base plate 21, the drive ring 22, the plurality of aperture blades 23, the drive motor 24, and one or more of the drive gears 24a. The base plate 21 has the substantially annular main body part 21a and the opening 21b that is provided at the center portion of the main body part 21a and allows light to pass through in the optical axis direction. The drive ring 22 has the substantially annular main body part 22a, the opening 22b provided at the center portion of the main body part 22a and allows light to pass through in the optical axis direction, and the gear portion 22c that is provided to the main body part 22a, and is engaged with the base plate 21 in a state of being able to rotate around the optical axis. The drive motor 24 is held by the base plate 21 and rotationally drives the drive ring 22 around the optical axis relative to the base plate 21. The one or more drive gears 24a transmit the rotation or rotational drive force transmitted from the drive motor 24 to the gear portion 22c. The aperture blades 23 are at least partially disposed in the space formed between the base plate 21 and the drive ring 22, form the opening 23b through which light that has passed through opening 21b passes, and adjusts the amount of light passing through by varying the size of the opening 23b by opening and closing (rotating) the aperture blades, and the aperture blades are opened or closed (rotated) when the drive ring 22 is rotated relative to the base plate 21 by the drive motor 24.

Consequently, the aperture blades 23 are configured to open and close in the gap between the base plate 21 and the drive ring 22, which allows the drive ring 22 to function as a conventional third frame body (cover).

As a result, fewer parts are required than with prior art, and costs can be reduced while keeping the size in the optical axis direction small.

### OTHER EMBODIMENTS

An embodiment of the present disclosure was described above, but the present disclosure is not limited to or by the above embodiment, and various modifications are possible without departing from the gist of the disclosure.

### (A)

In the above embodiment, an example was given in which the rotation shafts 21f serving as the rotation shafts of the aperture blades 23 were provided on the base plate 21. However, the present disclosure is not limited to this.

For example, the rotation shafts of the aperture blades (movable blades) may be integrally disposed on the drive ring (second frame body) side, rather than on the base plate (first frame body) side.

Here again, the same effect as obtained in the above embodiment can be obtained.

### (B)

In the above embodiment, an example was given in which the rotation shafts 21f serving as the rotation shafts of the aperture blades 23 were provided on the base plate 21. However, the present disclosure is not limited to this.

For example, the rotation shafts of the aperture blades (movable blades) may be provided somewhere other than on the base plate (first frame body) side, such as a configuration in which the rotation shafts are integrally disposed on the aperture blades (movable blades) themselves, and holes that engage with these shafts are be provided on the base plate side.

Here again, the same effect as obtained in the above embodiment can be obtained.

### (C)

In the above embodiment, an example was given in which the cam followers 22f that engaged with the cam slots 23d of the aperture blades 23 were provided on the drive ring 22. However, the present disclosure is not limited to this.

For example, the cam pins that engage with the cam grooves of the aperture blades (movable blades) may be provided on the base plate (first frame body) side, instead of on the drive ring side.

Here again, the same effect as obtained in the above embodiment can be obtained.

### (D)

In the above embodiment, an example was given in which the cam followers 22f that engaged with the cam slots 23d of the aperture blades 23 were provided on the drive ring 22. However, the present disclosure is not limited to this.

For example, the engaging cam pins may be disposed on the aperture blade (movable blade) side, and the cam grooves may be disposed on the drive ring side, the main plate side, or the cover side.

Here again, the same effect as obtained in the above embodiment can be obtained.

### (E)

In the above embodiment, an example was given in which the drive gear 24a of the drive motor 24 fixed to the base plate 21 and the recess 22g provided on the drive ring 22 side were used as members that defined the range of relative rotation of the base plate 21 relative to the drive ring 22. However, the present invention is not limited to this.

For example, a microprocessor that controls the rotation of a drive motor (drive source) may be used as a component that defines the range of relative rotation (drive range) of the base plate (first frame body) relative to the drive ring (second frame body).

Here again, the range of relative rotation (drive range) of the base plate (first frame body) relative to the drive ring (second frame body) can be defined by controlling the rotation of the drive motor (drive source) with a microprocessor.

### (F)

In the above embodiment, an example was given in which the aperture unit 20 included nine movable aperture blades 23. However, the present disclosure is not limited to this.

For example, the number of movable blades included in the aperture unit is not limited to nine, and may instead be eight or less, or ten or more.

### (G)

In the above embodiment, an example was given in which the content of the present disclosure was applied to the aperture unit 20 (light shielding unit) mounted on the lens barrel 10 with interchangeable lenses and that can be attached to and removed from a camera body. However, the present disclosure is not limited to this.

For example, the light shielding unit is not limited to being applied to an interchangeable lens barrel, and can instead be applied to a lens barrel that is integrated with a camera body.

### (H)

In the above embodiment, an example was given in which the content of the present disclosure was applied to the aperture unit 20 (light shielding unit) 20 mounted on the lens barrel 10 disposed downstream in the light incidence direction of the second lens L2 that functioned as a focus lens. However, the present disclosure is not limited to this.

For example, the aperture unit may be disposed upstream of the second lens L2 that functions as a focus lens in the light incidence direction.

### (I)

In the above embodiment, an example was given in which the base plate 21 of the aperture unit 20 was configured substantially integrally as a part of the second lens group unit 12 of the lens barrel 10. However, the present disclosure is not limited to this.

For example, the aperture unit 20 and the second lens group unit 12 may be separate components that are integrally joined together with screws or some other fastening method.

### (J)

In the above embodiment, an example was given in which the drive gear 24a attached to the drive motor 24 was used as the stopper. However, the present disclosure is not limited to this.

For example, so long as contact is possible with some of the shape of the drive motor 24 itself, or with a screw or metal fitting for attaching the drive motor 24, that is, the side wall 22ga or 22gb that is integral with the drive motor 24 and has a shape that protrudes toward the recess 22g in the optical axis X direction, the same effect as a stopper as in this embodiment can be obtained.

### (K)

In the above embodiment, an example was given in which the stoppers were defined by both ends of the recess 22g, that is, the side walls 22ga and 22gb. However, the present disclosure is not limited to this.

Just one of the two, such as just the side wall 22ga side (maximum aperture side, bayonet assembly start side, bayonet tab insertion side) may be used as the stopper. In this case, the other stopper (the opposite side from the minimum aperture side, bayonet assembly start side, and bayonet tab insertion side) will have the same effect as a stopper as in the above embodiment if, for example, a circumferential contact portion is formed on the tabs 21d and the latching portions 22db, which are the bayonet coupling portion between the base plate 21 and the drive ring 22, and is used as a stopper, or a circumferential contact portion is formed on the grooves 21e of the base plate 21 and the cam followers 22f of the drive ring 22, and is used as a stopper, or a circumferential contact portion is formed on the rotation shafts 21f of the base plate 21 and the grooves 22e of the drive ring 22, and is used as a stopper.

### (L)

In the above embodiment, an example was given in which the drive gear 24a, as the rotational drive transmission unit, was disposed more to the outside diameter side than the range in which the aperture blades 23 opened and closed. However, the present disclosure is not limited to this.

For example, the rotation shaft of the drive motor 24 serving as the rotational drive transmission unit may be disposed more to the outside diameter side than the range in which the aperture blades 23 open and close. In this case, the aperture blades 23 are disposed at positions overlapping the rotation shaft of the drive motor 24 in the optical axis X direction (as seen in a direction perpendicular to the optical axis X), but are disposed at positions not overlapping the drive gear 24a.

More specifically, the drive gear 24a is disposed closer to the drive ring 22 than the aperture blades 23 in the optical axis X direction (as seen in a direction perpendicular to the optical axis X), and meshes with the gear portion 22c of the drive ring 22. Therefore, the aperture blades 23 do not interfere with the rotation shaft of the drive motor 24, which is a rotational drive transmission unit, or the drive gear 24a, even when driven open and closed.

### (M)

In the above embodiment, the main body part 21a and the opening (first opening) 21b were integrally configured as a single member. However, the present disclosure is not limited to this.

For example, a separate member including the opening (first opening) 21b, such as a sheet-like member (not shown) that is thin in the optical axis X direction, may be supported by the main body part 21a and the two integrally configured. Again with this configuration, the same effect as in the above embodiment can be obtained.

### (N)

In the above embodiment, the main body part 22a and the opening (second opening) 22b were integrally formed as a single member. However, the present disclosure is not limited to this.

For example, a separate member including the opening (second opening) 22b, such as a sheet-like member (not shown) that is thin in the optical axis X direction, may be supported by the main body part 22a and the two integrally configured. Again with this configuration, the same effect as in the above embodiment can be obtained.

### (O)

In the above embodiment, an example was given in which the outside diameter (outside diameter of the main body part 22a) and inside diameter (diameter of the opening 22b) of the drive ring 22 relative to the optical axis X were substantially the same size (length) as the outside diameter (outside diameter of the main body part 21a) and inside diameter (diameter of the opening 21b) of the base plate 21 relative to the optical axis X. However, the present disclosure is not limited to this.

For example, when the aperture blades 23 are being opened or closed, as long as the rotation shafts 21f, the cam followers 22f, and the cam slots 23d are disposed overlapping the drive ring 22 when viewed in the optical axis X direction, the outside diameter and inside diameter of the drive ring 22 do not have to be substantially the same as those of the base plate 21.

Also, as long as the drive gear 24a, which is a rotational drive transmission unit, is disposed overlapping the drive ring 22 when viewed in the optical axis X direction in a state in which the aperture blades 23 are being opened and closed, the outside diameter and inside diameter of the drive ring 22 do not have to be substantially the same as those of the base plate 21. As an example, these diameters may be smaller than those of the base plate 21. Again with this configuration, the same effect as in the above embodiment can be obtained.

(P) In the above embodiment, an example was given in which gear coupling between the drive gear 24a, which is a rotational drive transmission unit, and the gear portion 22c, which is a rotation connection part, was used as the connection method for transmitting the rotation of the drive motor 24, which is a drive source, to the drive ring 22. However, the present disclosure is not limited to this.

For example, the connection method may be frictional coupling that involves pressing between an elastic roller, which is the rotational drive transmission unit, and the inner peripheral surface of the circumferential direction wall on the outer peripheral side of the drive ring 22, which is the rotation connection portion. As long as the rotational drive transmission unit is something that rotates in conjunction with the drive motor 24 and transmits rotation or rotational drive force from the drive motor 24 to the drive ring 22 by contact and connection with a part of the drive ring 22, the same effect as in this embodiment can be obtained.

(Q) In the above embodiment, an example was given in which the rotational drive force was transmitted directly from the drive gear 24a fixed to the drive motor 24 to the gear portion 22c of the drive ring 22. However, the present disclosure is not limited to this.

For example, one or more intermediate gears supported by the base plate 21 may be added between the drive gear 24a fixed to the drive motor 24 and the gear train of the gear portion 22c of the drive ring 22. The intermediate gears may include a stepped gear having a speed reducing effect. Again with this configuration, the same effect as this embodiment can be obtained.

### (R)

In the above embodiment, an example was given in which the drive gear 24a, as the rotational drive transmission unit, was disposed on the outside diameter side of the range in which the aperture blades 23 opened and closed. However, the present disclosure is not limited to this.

For example, one or more intermediate gears may be added between the gear train of the drive gear 24a fixed to the drive motor 24 and the gear portion 22c of the drive ring 22, and the drive gear 24a and one or more of the one or more intermediate gears may be configured as a rotational drive transmission unit and disposed on the outside diameter side of the range in which the aperture blades 23 open and close. Again with this configuration, the same effect as this embodiment can be obtained.

### Additional Disclosure

The above description of the embodiments discloses the following techniques.

### Technique 1

The light shielding unit according to Technique 1 comprises:
a first frame body that has a substantially annular first main body part, and a first opening provided in a center part of the first main body part and allowing light to pass through in an optical axis direction;
a second frame body that has a substantially annular second main body part, a second opening provided in a center part of the second main body part and allowing light to pass through in the optical axis direction, and a rotation connection portion provided to the second main body part, and the second frame body configured to engage with the first frame body in a state of being rotatable around the optical axis;
a drive source that is held by the first frame body and rotationally drives the second frame body relative to the first frame body around the optical axis;
one or more rotational drive transmission units that transmit the rotation or the rotational drive force transmitted from the drive source to the rotation connection unit; and
a plurality of movable blades, at least a portion of which is disposed in a space formed between the first frame body and the second frame body, which form a third opening through which passes the light that has passed through the first opening or the second opening, which are driven open or closed when the second frame body is rotated relative to the first frame body by the drive source, and which adjust the amount of light passing through by changing the size of the third opening by opening or closing.

### Technique 2

The light shielding unit according to Technique 2 is the light shielding unit according to the Technique 1,
wherein the rotation connection portion is provided on the outer peripheral side of the second frame body.

### Technique 3

The light shielding unit according to Technique 3 is the light shielding unit according to Technique 1 or 2,
wherein the rotation connection portion and one or more members of the one or more rotational drive transmission units are disposed so as to engage further to an outside in a radial direction centered on the optical axis than one or more of the plurality of movable blades.

### Technique 4

The light shielding unit according to Technique 4 is the light shielding unit according to any of Techniques 1 to 3,
wherein the one or more rotational drive transmission units are configured by a gear configured to rotate in conjunction with the drive source, and the rotation connection portion is configured by a gear provided on an outer peripheral side of the second frame body.

### Technique 5

The light shielding unit according to Technique 5 is the light shielding unit according to any of Techniques 1 to 4,
wherein the second frame body further has a recess in the optical axis direction in which is disposed an optical axis direction protruding portion that is included in the drive source attached to the first frame body.

### Technique 6

The light shielding unit according to Technique 6 is the light shielding unit according to Technique 5,
wherein the recess defines a range of relative rotation between the first frame body and the second frame body by coming into contact with the protruding portion at both ends thereof in the optical axis direction.

### Technique 7

The light shielding unit according to Technique 7 is the light shielding unit according to any of Techniques 1 to 6,
wherein the second frame body is engaged with the first frame body in a state of being substantially immobile in the optical axis direction, and the plurality of movable blades are driven open and closed while their movement in the optical axis direction is restricted in a gap formed between the first frame body and the second frame body.

### Technique 8

The light shielding unit according to Technique 8 is the light shielding unit according to any of Techniques 1 to 7,
wherein the second frame body is engaged with the first frame body at an outer peripheral side of the first main body part or the second main body part.

### Technique 9

The light shielding unit according to Technique 9 is the light shielding unit according to any of Techniques 1 to 8,
wherein the second frame body is engaged with the first frame body further to an outside in a radial direction centered on the optical axis than one or more of the plurality of movable blades.

### Technique 10

The light shielding unit according to Technique 10 is the light shielding unit according to Technique 8 or 9,
wherein the second frame body is engaged with the first frame body by a bayonet coupling.

### Technique 11

The light shielding unit according to Technique 11 is the light shielding unit according to Technique 10,
wherein a latching length between the first frame body and the second frame body which are latched together by the bayonet coupling is at its minimum when the movable blades are in a fully open (open, maximum opening) state, and is at its maximum when the movable blades are in a minimum aperture state.

### Technique 12

The light shielding unit according to Technique 12 is the light shielding unit according to Technique 11,
wherein when the first frame body is rotated relative to the second frame body in a direction in which the latching length becomes further shorter from a position where the latching length of the bayonet coupling is at its minimum, the rotational drive transmission unit restricts a rotation of the first frame body at a position just ahead of where the latching length reaches zero.

### Technique 13

The light shielding unit according to Technique 13 is the light shielding unit according to any of Techniques 1 to 12, further comprising:
a rotation shaft that is disposed on either the first frame body, the second frame body, or the movable blades and that is configured to rotationally drive the movable blades;
a cam follower that is disposed on either the first frame body, the second frame body, or the movable blades and that is configured to rotationally drive the movable blade; and
a cam groove that is disposed on either the first frame body, the second frame body, or the movable blades and that is configured to rotationally drive the movable blades,
wherein the rotation shaft, the cam follower, and the cam groove are disposed so as to overlap the second frame body when viewed in the optical axis direction.

### Technique 14

The light shielding unit according to Technique 14 is the light shielding unit according to any of Techniques 1 to 13,
wherein the one or more rotational drive transmission units are disposed so as to overlap the second frame body when viewed in the optical axis direction.

### Technique 15

The light shielding unit according to Technique 15 is the light shielding unit according to any of Techniques 1 to 14,
wherein some or all of the first frame body constitutes an outer shape of a first side in the optical axis direction, and some or all of the second frame body constitutes an outer shape of a second side opposite to the first side in the optical axis direction.

### Technique 16

The lens barrel according to Technology 16 comprises:
the light shielding unit according to any of Techniques 1 to 15; and one or more lenses configured to guide the light incident on the light shielding unit in a desired direction.

### Technique 17

The lens barrel according to Technique 17 is the lens barrel according to Technique 16,
wherein the light shielding unit is an aperture unit configured to adjust the amount of light that passes through the one or more lenses.

### Technique 18

The lens barrel according to Technique 18 comprises:
a first frame body that has a substantially annular first main body part and a first opening provided in a center portion of the first main body part and allowing light to pass through in an optical axis direction;
a second frame body that engages a substantially annular second main body part and a second opening provided in the center part of the second main body part and allowing light to pass through in the optical axis direction, in a state of being rotatable relative to the first frame body around the optical axis;
a drive source that is held by the first frame body and is configured to rotationally drive the second frame body relative to the first frame body around the optical axis; and
a plurality of movable blades, at least a portion of which is disposed in a space formed between the first frame body and the second frame body, which form a third opening through which passes the light that has passed through the first opening or the second opening, which are driven open or closed when the second frame body is rotated relative to the first frame body by the drive source, and which is configured to adjust an amount of light passing through by changing a size of the third opening by opening or closing,
wherein some or all of the first frame body configures an outer shape of a first side in the optical axis direction, and some or all of the second frame body configures an outer shape of a second side opposite to the first side in the optical axis direction.

### Technique 19

The light shielding unit according to Technique 19 is the light shielding unit according to Technique 18,
wherein the second frame body is engaged with the first frame body in a state of being substantially immobile in the optical axis direction, and the plurality of movable blades are driven open and closed while their movement in the optical axis direction is restricted in a gap formed between the first frame body and the second frame body.

### Technique 20

The light shielding unit according to Technique 20 is the light shielding unit according to Technique 19,
wherein the second frame body is engaged with the first frame body on an outer peripheral side of the first main body part or the second main body part.

### Technique 21

The light shielding unit according to Technique 21 is the light shielding unit according to Technique 18,
wherein the second frame body is engaged with the first frame body further to an outside in a radial direction centered on the optical axis than one or more of the plurality of movable blades.

### Technique 22

The light shielding unit according to Technique 22 is the light shielding unit according to any of Techniques 18 to 21,
wherein the second frame body is engaged with the first frame body by the bayonet coupling.

### Technique 23

The light shielding unit according to Technique 23 is the light shielding unit according to any of Techniques 18 to 22, further comprising:
a rotation shaft that is disposed on either the first frame body, the second frame body, or the movable blades and that is configured to rotationally drive the movable blades;
a cam follower that is disposed on either the first frame body, the second frame body, or the movable blades and that rotationally drives the movable blades; and
a cam groove that is disposed on either the first frame body, the second frame body, or the movable blades and that is configured to rotationally drive the movable blades,
wherein the rotation shaft, the cam follower, and the cam groove are disposed so as to overlap the second frame body when viewed in the optical axis direction.

### Technique 24

The lens barrel according to Technology 24 comprises:
the light shielding unit according to any of Techniques 18 to 23; and one or more lenses configured to guide the light incident on the light shielding unit in a desired direction.

### Technique 25

The lens barrel according to Technique 25 is the lens barrel according to Technique 24,
wherein the light shielding unit is an aperture unit configured to adjust the amount of light that passes through one or more of the lenses.

### INDUSTRIAL APPLICABILITY

The light shielding unit of the present disclosure exhibits the effect of suppressing an increase in size in the optical axis direction, reducing the number of parts, and lowering costs, and can therefore be broadly applied to various kinds of device such as optical instruments that are equipped with a light shielding unit.

### REFERENCE SIGNS LIST

10 lens barrel
11 first lens group unit
11a cam pin
11b rectilinear protrusion
12 second lens group unit
12a main body part
12b lens holder
12c rectilinear groove
12d bayonet rib
13 third lens group unit
13a cam pin
14 cam frame
14a cam groove
14b cam groove
14c bayonet groove
15 rectilinear frame
15a rectilinear groove
20 aperture unit (light shielding unit)
21 base plate (first frame body)
21a main body part (first main body part)
21b opening (first opening)
21c attachment portion
21ca through-hole
21d tab
21e groove
21f rotation shaft
22 drive ring (second frame body)
22a main body part (second main body part)
22b opening (second opening)
22c gear portion (rotation connection portion)
22da insertion portion
22db latching part
22dc outer peripheral wall
22dd bayonet groove
22e groove
22f cam follower
22g recess
22ga side wall (first mechanical end)
22gb side wall (second mechanical end)
23 aperture blade (movable blade)
23a blade
23b opening (third opening)
23c through-hole
23d cam slot
24 drive motor (drive source)
24a drive gear (rotational drive transmission unit)
A1 latching portion (minimum)
A2 latching portion (maximum)
L1 to L3 first to third lenses (lens group)
X optical axis

What is claimed is:

1. A light shielding unit, comprising:
a first frame body that has a substantially annular first main body part, and a first opening provided in a center part of the first main body part and allowing light to pass through in an optical axis direction;
a second frame body that has a substantially annular second main body part, a second opening provided in a center part of the second main body part and allowing light to pass through in the optical axis direction, and a rotation connection portion provided to the second main body part, and the second frame body configured to be engaged with the first frame body in a state of being rotatable around the optical axis;
a drive source that is held by the first frame body and is configured to rotationally drives the second frame body around the optical axis relative to the first frame body;
one or more rotational drive transmission units configured to transmit a rotation or a rotational drive force transmitted from the drive source to the rotation connection portion; and
a plurality of movable blades that are at least partially disposed in a space formed between the first frame body and the second frame body, which form a third opening through which passes the light that has passed through the first opening or the second opening, which are driven open or closed when the second frame body is rotated relative to the first frame body by the drive source, and which is configured to adjust an amount of light passing through by changing a size of the third opening by opening or closing.

2. The light shielding unit according to claim 1,
wherein the rotation connection portion is provided on an outer peripheral side of the second frame body.

3. The light shielding unit according to claim 1,
wherein the rotation connection portion and one or more members of the one or more rotational drive transmission units are disposed so as to engage further to an outside in a radial direction centered on the optical axis than one or more of the plurality of movable blades.

4. The light shielding unit according to claim 1,
wherein the one or more rotational drive transmission units are configured by a gear configured to rotate in conjunction with the drive source, and the rotation connection portion is configured by a gear provided on an outer peripheral side of the second frame body.

5. The light shielding unit according to claim 1,
wherein the second frame body is engaged with the first frame body in a state of being substantially immovable in the optical axis direction, and the plurality of movable blades are driven open and closed while their movement in the optical axis direction is restricted in a gap formed between the first frame body and the second frame body.

6. The light shielding unit according to claim 1,
wherein the second frame body is engaged with the first frame body on an outer peripheral side of the first main body part or the second main body part.

7. The light shielding unit according to claim 1,
wherein the second frame body is engaged with the first frame body further to an outside in a radial direction centered on the optical axis than one or more of the plurality of movable blades.

8. The light shielding unit according to claim 6,
wherein the second frame body is engaged with the first frame body by a bayonet coupling.

9. The light shielding unit according to claim 1, further comprising:
a rotation shaft that is disposed on either the first frame body, the second frame body, or the movable blades and that is configured to rotationally drive the movable blades;
a cam follower that is disposed on either the first frame body, the second frame body, or the movable blades and that is configured to rotationally drive the movable blade; and
a cam groove that is disposed on either the first frame body, the second frame body, or the movable blades and that is configured to rotationally drive the movable blades,
wherein the rotation shaft, the cam follower, and the cam groove are disposed so as to overlap the second frame body when viewed in the optical axis direction.

10. The light shielding unit according to claim 1,
wherein the one or more rotational drive transmission units are disposed so as to overlap the second frame body when viewed in the optical axis direction.

11. The light shielding unit according to claim 1,
wherein some or all of the first frame body constitutes an outer shape of a first side in the optical axis direction, and some or all of the second frame body constitutes an outer shape of a second side opposite to the first side in the optical axis direction.

12. A lens barrel, comprising:
the light shielding unit according to claim 1; and
one or more lenses configured to guide the light incident on the light shielding unit in a desired direction.

13. The lens barrel according to claim 12,
wherein the light shielding unit is an aperture unit that is configured to adjust the amount of light passing through one or more of the lenses.

14. A light shielding unit, comprising:
a first frame body that has a substantially annular first main body part, and a first opening provided in a center part of the first main body part and allowing light to pass through in an optical axis direction;
a second frame body that has a substantially annular second main body part, and a second opening provided in the center part of the second main body part and allowing light to pass through in the optical axis direction, and that engages with the first frame body in a state of being rotatable around the optical axis;
a drive source that is held by the first frame body and is configured to rotationally drive the second frame body relative to the first frame body around the optical axis; and
a plurality of movable blades, at least a portion of which is disposed in a space formed between the first frame body and the second frame body, which form a third opening through which passes the light that has passed through the first opening or the second opening, which are driven open or closed when the second frame body is rotated relative to the first frame body by the drive source, and which is configured to adjust an amount of light passing through by changing a size of the third opening by opening or closing, wherein some or all of the first frame body configures an outer shape of a first side in the optical axis direction, and some or all of the second frame body configures an outer shape of a second side opposite to the first side in the optical axis direction.

15. The light shielding unit according to claim 14,
wherein the second frame body is engaged with the first frame body in a state of being substantially immovable in the optical axis direction, and the plurality of movable blades are driven open and closed while their movement in the optical axis direction is restricted in a gap formed between the first frame body and the second frame body.

16. The light shielding unit according to claim 15,
wherein the second frame body is engaged with the first frame body on an outer peripheral side of the first main body part or the second main body part.

17. The light shielding unit according to claim 14,
wherein the second frame body is engaged with the first frame body further to an outside in a radial direction centered on the optical axis than one or more of the plurality of movable blades.

18. The light shielding unit according to claim 14, further comprising:
a rotation shaft that is disposed on either the first frame body, the second frame body, or the movable blades and that is configured to rotationally drive the movable blades;
a cam follower that is disposed on either the first frame body, the second frame body, or the movable blades and that rotationally drives the movable blades; and
a cam groove that is disposed on either the first frame body, the second frame body, or the movable blades and that is configured to rotationally drive the movable blades,
wherein the rotation shaft, the cam follower, and the cam groove are disposed so as to overlap the second frame body when viewed in the optical axis direction.

19. A lens barrel, comprising:
the light shielding unit according to claim 14; and
one or more lenses configured to guide the light incident on the light shielding unit in a desired direction.

20. The lens barrel according to claim 19,
wherein the light shielding unit is an aperture unit configured to adjust the amount of light passing through one or more of the lenses.
